(19) United States
(12) Patent Application Publication
(10) Pub. No.: US 2025/0088078 A1
(43) Pub. Date: Mar. 13, 2025

(54) MAGNET TEMPERATURE INFORMATION OUTPUT DEVICE, ROTATING ELECTRICAL MACHINE, AND MAGNET TEMPERATURE ACQUISITION DEVICE

(71) Applicant: TDK Corporation, Tokyo (JP)

(72) Inventors: Chen WANG, Tokyo (JP); Koji MITAKE, Tokyo (JP)

(73) Assignee: TDK Corporation, Tokyo (JP)

(21) Appl. No.: 18/827,904

(22) Filed: Sep. 9, 2024

(30) Foreign Application Priority Data
Sep. 13, 2023 (JP) 2023-148697
May 31, 2024 (JP) 2024-089054

(51) Int. Cl. H02K 11/25; H02K 1/27

(52) U.S. Cl. CPC H02K 11/25; H02K 1/27

(57) ABSTRACT

A magnet temperature information output device includes a first element provided on a rotor, a second element provided on a stator, an electric resistance element, and an output section. The first element includes a temperature sensitive element and a first coil. In the temperature sensitive element, electric resistance changes responding to a temperature of the permanent magnet. The first coil is electrically connected to the temperature sensitive element. The second element includes a second coil. The second coil is arranged to be magnetically coupled to the first coil. The electric resistance element is electrically connected to the second element. The output section is electrically connected to the second element and the electric resistance element. The output section is arranged to output an electric signal responding to a magnitude of a voltage drop occurring in the electric resistance element as temperature information regarding the temperature of the permanent magnet.

### CROSS-REFERENCE TO RELATED APPLICATIONS

This application is based upon and claims the benefit of priority from Japanese Patent Application No. 2024-089054, filed On May 31, 2024, and Japanese Patent Application No. 2023-148697, filed On Sep. 13, 2023, the entire contents of each are incorporated herein by reference.

### BACKGROUND

### Field

The present disclosure relates to a magnet temperature information output device, a rotating electrical machine provided with the magnet temperature information output device, and a magnet temperature acquisition device including the magnet temperature information output device.

### Description of the Related Art

Known magnet temperature information output devices are provided for a rotating electrical machine including a stator and a rotor in which a permanent magnet is disposed and are arranged to output temperature information regarding a temperature of a permanent magnet (see e.g., Japanese Unexamined Patent Publication No. 2021-39019.). The magnet temperature information output device includes a temperature sensitive element, a first coil, a second coil, and an output section. The temperature sensitive element is provided on the rotor, and the electric resistance changes in response to the temperature of the permanent magnet. The first coil is electrically connected to the temperature sensitive element. The second coil is provided on the stator and is arranged to be magnetically coupled to the first coil. The output section is arranged to output an electric signal responding to a magnitude of the current flowing through the second coil.

### SUMMARY

One aspect of the present disclosure provides a magnet temperature information output device that outputs temperature information regarding a temperature of a permanent magnet as an electric signal regarding a voltage. Another aspect of the present disclosure provides a rotating electrical machine that outputs temperature information regarding a temperature of a permanent magnet as an electric signal regarding a voltage. Another further aspect of the present disclosure provides a magnet temperature acquisition device that obtains the temperature of the permanent magnet based on the electric signal related to the voltage.

A magnet temperature information output device according to one aspect is provided for a rotating electrical machine including a stator and a rotor in which a permanent magnet is disposed, and is arranged to output temperature information regarding a temperature of the permanent magnet. The magnet temperature information output device includes a first element provided on the rotor, a second element provided on the stator, an electric resistance element, and an output section. The first element includes a temperature sensitive element and a first coil. In the temperature sensitive element, electric resistance changes in response to the temperature of the permanent magnet. The first coil is electrically connected to the temperature sensitive element. The second element includes a second coil. The second coil is arranged to be magnetically coupled to the first coil. The electric resistance element is electrically connected to the second element. The output section is electrically connected to the second element and the electric resistance element. The output section is arranged to output an electric signal responding to a magnitude of a voltage drop occurring in the electric resistance element as the temperature information.

A rotating electrical machine according to another aspect includes a stator, a rotor in which a permanent magnet is disposed, and a magnet temperature information output device that is arranged to output temperature information regarding a temperature of the permanent magnet. The magnet temperature information output device includes a first element provided on the rotor, a second element provided on the stator, an electric resistance element, and an output section. The first element includes a temperature sensitive element and a first coil. In the temperature sensitive element, electric resistance changes in response to the temperature of the permanent magnet. The first coil is electrically connected to the temperature sensitive element. The second element includes a second coil. The second coil is arranged to be magnetically coupled to the first coil. The electric resistance element is electrically connected to the second element. The output section is electrically connected to the second element and the electric resistance element. The output section is arranged to output an electric signal responding to a magnitude of a voltage drop occurring in the electric resistance element as the temperature information.

A magnet temperature acquisition device according to another further aspect includes a magnet temperature information output device. The magnet temperature information output device is provided for a rotating electrical machine including a stator and a rotor in which a permanent magnet is disposed, and is arranged to output temperature information regarding a temperature of the permanent magnet. The magnet temperature information output device includes a first element provided on the rotor, a second element provided on the stator, an electric resistance element, and an output section. The first element includes a temperature sensitive element and a first coil. In the temperature sensitive element, electric resistance changes in response to the temperature of the permanent magnet. The first coil is electrically connected to the temperature sensitive element. The second element includes a second coil. The second coil is arranged to be magnetically coupled to the first coil. The electric resistance element is electrically connected to the second element. The output section is electrically connected to the second element and the electric resistance element. The output section is arranged to output an electric signal responding to a magnitude of a voltage drop occurring in the electric resistance element as temperature information. The magnet temperature acquisition device is arranged to acquire the electric signal output from the magnet temperature information output device, and is arranged to obtain the temperature of the permanent magnet based on the acquired electric signal.

### BRIEF DESCRIPTION OF THE DRAWINGS

FIG. 1 is a schematic diagram illustrating a configuration of a magnet temperature information output device and a rotating electrical machine according to one embodiment;

FIG. 2 is a circuit diagram illustrating an example of the magnet temperature information output device;

FIG. 3 is a circuit diagram illustrating an equivalent circuit used for setting an electric resistance of an electric resistance element;

FIG. 4 is a circuit diagram illustrating an equivalent circuit used for setting the electric resistance of the electric resistance element;

FIG. 5 is a diagram illustrating a cross-sectional configuration of a rotor core;

FIG. 6 is a circuit diagram illustrating another example of the magnet temperature information output device;

FIG. 7 is a circuit diagram illustrating an equivalent circuit used for setting the electric resistance of the electric resistance element;

FIG. 8 is a circuit diagram illustrating an equivalent circuit used for setting the electric resistance of the electric resistance element;

FIG. 9 is a circuit diagram illustrating still another example of the magnet temperature information output device;

FIG. 10 is a circuit diagram illustrating an equivalent circuit used for setting the electric resistance of the electric resistance element;

FIG. 11 is a circuit diagram illustrating an equivalent circuit used for setting the electric resistance of the electric resistance element;

FIG. 12 is a diagram illustrating a cross-sectional configuration of a rotor core;

FIG. 13 is a diagram illustrating a cross-sectional configuration of a rotor core;

FIG. 14 is a circuit diagram illustrating an equivalent circuit used when obtained the relationship between the electric resistance of the electric resistance element and the accuracy of temperature information;

FIG. 15 is a table illustrating a relationship between electric resistance of an electric resistance element and accuracy of temperature information;

FIG. 16 is a table illustrating a relationship between electric resistance of an electric resistance element and accuracy of temperature information;

FIG. 17 is a diagram illustrating a relationship between a voltage drop occurring in the electric resistance element and a temperature;

FIG. 18 is a diagram illustrating a relationship between a voltage drop occurring in the electric resistance element and a temperature;

FIG. 19 is a diagram illustrating a relationship between a voltage drop occurring in the electric resistance element and a temperature;

FIG. 20 is a diagram illustrating a relationship between a voltage drop occurring in the electric resistance element and a temperature;

FIG. 21 is a diagram illustrating a relationship between a voltage drop occurring in the electric resistance element and a temperature;

FIG. 22 is a diagram illustrating a relationship between a voltage drop occurring in the electric resistance element and a temperature; and

FIG. 23 is a diagram illustrating a relationship between a voltage drop occurring in the electric resistance element and a temperature.

### DETAILED DESCRIPTION

One aspect of the present disclosure provides a magnet temperature information output device that outputs temperature information regarding a temperature of a permanent magnet as an electric signal regarding a voltage. Another aspect of the present disclosure provides a rotating electrical machine that outputs temperature information regarding a temperature of a permanent magnet as an electric signal regarding a voltage. Another further aspect of the present disclosure provides a magnet temperature acquisition device that obtains the temperature of the permanent magnet based on the electric signal related to the voltage.

A magnet temperature information output device according to one aspect is provided for a rotating electrical machine including a stator and a rotor in which a permanent magnet is disposed, and is arranged to output temperature information regarding a temperature of the permanent magnet. The magnet temperature information output device includes a first element provided on the rotor, a second element provided on the stator, an electric resistance element, and an output section. The first element includes a temperature sensitive element and a first coil. In the temperature sensitive element, electric resistance changes in response to the temperature of the permanent magnet. The first coil is electrically connected to the temperature sensitive element. The second element includes a second coil. The second coil is arranged to be magnetically coupled to the first coil. The electric resistance element is electrically connected to the second element. The output section is electrically connected to the second element and the electric resistance element. The output section is arranged to output an electric signal responding to a magnitude of a voltage drop occurring in the electric resistance element as the temperature information.

In the one aspect, the magnet temperature information output device includes the electric resistance element electrically connected to the second element. Since the second coil included in the second element is arranged to be magnetically coupled to the first coil, electric power is supplied to the first coil. Since the electric resistance of the temperature sensitive element electrically connected to the first coil changes in response to the temperature of the permanent magnet, the current flowing through the second coil changes in response to the change in the electric resistance of the temperature sensitive element. When the current flowing through the second coil changes, the magnitude of the voltage drop occurring in the electric resistance element also changes. The output section is arranged to output the electric signal responding to the magnitude of the voltage drop occurring in the electric resistance element. Therefore, the electric signal output from the output section changes in response to the temperature of the permanent magnet. That is, in the one aspect, the temperature information regarding the temperature of the permanent magnet is output from the output section as an electric signal related to a voltage. From the above, in the one aspect, the temperature information regarding the temperature of the permanent magnet is output as the electric signal related to the voltage.

In the one aspect, the electric resistance element may have an electric resistance of greater than or equal to Zₒ^{0.50}×Z₁₅₀^{0.28} and less than or equal to Zₒ^{0.50}×Z₁₅₀^{0.71}. Here, Z₁₅₀ may be a combined impedance of the first element and the second element in a state where the first coil and the second coil are magnetically coupled and the temperature of a temperature sensitive element is 150° C. Zₒ may be a combined impedance of the first element and the second element in a state where the first coil and the second coil are magnetically coupled, without the temperature sensitive element included in the first element.

A configuration in which the electric resistance element has the electric resistance of greater than or equal to Zₒ^{0.50}×Z₁₅₀^{0.28} and less than or equal to Zₒ^{0.50} ×Z₁₅₀^{0.71} accurately outputs temperature information regarding the temperature of the permanent magnet.

In the one aspect, the second element may include a capacitor forming an LC resonance circuit with the second coil.

A configuration in which the second element includes the capacitor forming the LC resonance circuit with the second coil accurately detects the change in the electric resistance of the temperature sensitive element. Therefore, this configuration accurately outputs the temperature information regarding the temperature of the permanent magnet.

In the one aspect, the first element may include a capacitor forming an LC resonance circuit with the first coil.

A configuration in which the first element includes the capacitor forming the LC resonance circuit with the first coil accurately detects the change in the electric resistance of the temperature sensitive element. Therefore, this configuration accurately outputs the temperature information regarding the temperature of the permanent magnet.

In the one aspect, the first element may include a capacitor forming an LC resonance circuit with the first coil. The second element may include a capacitor forming an LC resonance circuit with the second coil.

A configuration in which the first element and the second element include the capacitor accurately outputs the temperature information regarding the temperature of the permanent magnet.

In the one aspect, the second coil may be arranged to be applied with a voltage having a frequency smaller than a predetermined resonance frequency for exciting the first coil.

A configuration in which the second coil is arranged to be applied with the voltage having the frequency smaller than the predetermined resonance frequency for exciting the first coil accurately outputs the temperature information regarding the temperature of the permanent magnet.

In the one aspect, a difference between the frequency of the voltage applied to the second coil and the predetermined resonance frequency may be greater than or equal to 5 kHz and smaller than or equal to 30 kHz.

A configuration in which the difference between the frequency of the voltage applied to the second coil and the predetermined resonance frequency is greater than or equal to 5 kHz and smaller than or equal to 30 kHz accurately outputs the temperature information regarding the temperature of the permanent magnet.

A rotating electrical machine according to another aspect includes

a stator, a rotor in which a permanent magnet is disposed, and a magnet temperature information output device that is arranged to output temperature information regarding a temperature of the permanent magnet. The magnet temperature information output device includes a first element provided on the rotor, a second element provided on the stator, an electric resistance element, and an output section. The first element includes a temperature sensitive element and a first coil. In the temperature sensitive element, electric resistance changes in response to the temperature of the permanent magnet. The first coil is electrically connected to the temperature sensitive element. The second element includes a second coil. The second coil is arranged to be magnetically coupled to the first coil. The electric resistance element is electrically connected to the second element. The output section is electrically connected to the second element and the electric resistance element. The output section is arranged to output an electric signal responding to a magnitude of a voltage drop occurring in the electric resistance element as the temperature information.

In another aspect described above, the rotating electrical machine includes the magnet temperature information output device. The magnet temperature information output device includes the electric resistance element electrically connected to the second element. Since the second coil included in the second element is arranged to be magnetically coupled to the first coil, electric power is supplied to the first coil. Since the electric resistance of the temperature sensitive element electrically connected to the first coil changes in response to the temperature of the permanent magnet, the current flowing through the second coil changes in response to the change in the electric resistance of the temperature sensitive element. When the current flowing through the second coil changes, the magnitude of the voltage drop occurring in the electric resistance element also changes. The output section is arranged to output the electric signal responding to the magnitude of the voltage drop occurring in the electric resistance element. Therefore, the electric signal output from the output section changes in response to the temperature of the permanent magnet. That is, in another aspect described above, the temperature information regarding the temperature of the permanent magnet is output from the output section as an electric signal related to a voltage. From the above, in another aspect described above, the temperature information regarding the temperature of the permanent magnet is output as the electric signal related to the voltage.

In another aspect described above, the first coil and the second coil may be disposed to oppose each other in the rotation axis direction of the rotor in a state where the rotor is at a predetermined rotation angle position.

In another aspect described above, the rotor may include a rotor core. The entire permanent magnet and at least a part of the first coil may be positioned in the rotor core. The permanent magnet may include a pair of surfaces perpendicular to the rotation axis direction of the rotor. The temperature sensitive element may be disposed to be in contact with a surface of the pair of surfaces that is closer to the second coil in a state where the rotor is at a predetermined rotation angle position.

In another aspect described above, the rotor core may include a pair of end surfaces perpendicular to the rotation axis direction of the rotor. An end surface of the pair of end surfaces closer to the second coil may be on the same plane as an end of the first coil in the rotation axis direction.

In another aspect described above, the rotor core may include a plurality of steel sheets stacked in the rotation axis direction and a plate. The plurality of steel sheets may have magnetism. The plate may have electric conductivity. The plate may be disposed on a steel sheet disposed on an outermost side in the rotation axis direction of the rotor and closer to the second coil among the plurality of steel sheets. The first coil may be embedded in the plate.

A magnet temperature acquisition device according to another further aspect includes a magnet temperature information output device. The magnet temperature information output device is provided for a rotating electrical machine including a stator and a rotor in which a permanent magnet is disposed, and is arranged to output temperature information regarding a temperature of the permanent magnet. The magnet temperature information output device includes a first element provided on the rotor, a second element provided on the stator, an electric resistance element, and an output section. The first element includes a temperature sensitive element and a first coil. In the temperature sensitive element, electric resistance changes in response to the temperature of the permanent magnet. The first coil is electrically connected to the temperature sensitive element. The second element includes a second coil. The second coil is arranged to be magnetically coupled to the first coil. The electric resistance element is electrically connected to the second element. The output section is electrically connected to the second element and the electric resistance element. The output section is arranged to output an electric signal responding to a magnitude of a voltage drop occurring in the electric resistance element as temperature information. The magnet temperature acquisition device is arranged to acquire the electric signal output from the magnet temperature information output device, and is arranged to obtain the temperature of the permanent magnet based on the acquired electric signal.

Since another further aspect described above includes the magnet temperature information output device, the temperature of the permanent magnet is obtained based on the electric signal related to the voltage.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

Hereinafter, examples of the present disclosure will be described in detail with reference to the accompanying drawings. In the following description, the same elements or elements having the same functions are denoted with the same reference numerals and overlapped explanation is omitted.

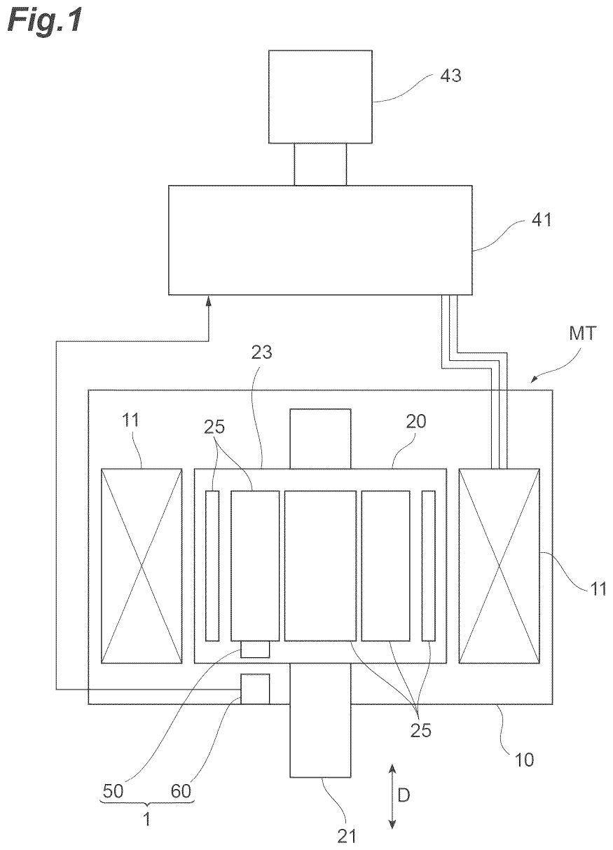

With reference to FIG. 1, a configuration of a magnet temperature information output device 1 and a rotating electrical machine MT provided with the magnet temperature information output device 1 according to the present embodiment will be described. FIG. 1 is a schematic diagram illustrating a configuration of a magnet temperature information output device and a rotating electrical machine according to the present embodiment.

As illustrated in FIG. 1, the magnet temperature information output device 1 is provided in the rotating electrical machine MT. The rotating electrical machine MT includes, for example, a motor. The motor includes, for example, an IPM motor or an SPM motor. As illustrated in FIG. 1, the rotating electrical machine MT includes a stator 10 and a rotor 20. The rotor 20 is located inside the stator 10.

The rotor 20 includes a shaft 21, a rotor core 23, and a plurality of permanent magnets 25. The shaft 21 has a columnar shape. The rotor core 23 has a cylindrical shape. A shaft hole into which the shaft 21 is fitted is formed in the rotor core 23. The shaft 21 and the rotor core 23 rotate integrally around a central axis of the shaft 21. Each permanent magnet 25 is disposed in the rotor core 23 such that an extending direction of each permanent magnet 25 is parallel to the central axis of the shaft 21. “The extending direction of the permanent magnet 25 and the central axis of the shaft 21 are parallel” does not merely mean that the extending direction of the permanent magnet 25 and the central axis of the shaft 21 are parallel. The fact that the extending direction of the permanent magnet 25 is parallel to the central axis of the shaft 21 includes the fact that a slight difference in a predetermined range, a manufacturing error, or a measurement error is included in an angle formed by the extending direction of the permanent magnet 25 and the central axis of the shaft 21. In a case where the slight difference in the predetermined range is included in the angle formed by the extending direction of the permanent magnet 25 and the central axis of the shaft 21, the fact that the extending direction of the permanent magnet 25 and the central axis of the shaft 21 are parallel includes, for example, that the angle is within a range of ±2 degrees. The central axis of the shaft 21 includes a rotation axis of the rotor 20. The direction in which the rotation axis of the rotor 20 extends includes a rotation axis direction D of the rotor 20. One magnet may constitute one pole, or a plurality of magnets may constitute one pole. In a configuration in which one magnet constitutes one pole, the plurality of permanent magnets 25 are arranged at equal angular intervals with respect to the rotation axis of the rotor 20. “Equal angular interval” does not merely mean that the angular intervals coincide. The fact that the angular intervals are equal includes the fact that the slight difference in the predetermined range, the manufacturing error, or the measurement error is included in the difference in angular intervals. In a case where the slight difference in the predetermined range is included in the difference in the angular intervals, the fact that each angular interval with respect to the rotation axis of the rotor 20 of the permanent magnet 25 is equal includes, for example, the fact that each angular interval with respect to the rotation axis of the rotor 20 of the permanent magnet 25 is within a range of ±10% with respect to an average angular interval of all angular intervals.

In a configuration in which the rotating electrical machine MT includes the IPM motor, the plurality of permanent magnets 25 are disposed in the rotor core 23. In a configuration in which the rotating electrical machine MT includes the SPM motor, the plurality of permanent magnets 25 are disposed on the surface of the rotor core 23. Each permanent magnet 25 includes a rare-earth-based permanent magnet.

Each permanent magnet 25 includes, for example, a neodymium-based sintered magnet. Each permanent magnet 25 may include a sintered magnet other than the rare-earth-based permanent magnet, or may include a magnet other than the sintered magnet. The magnet other than the sintered magnet includes, for example, a bonded magnet or a hot worked magnet.

The stator 10 includes a cylindrical stator core (not illustrated) disposed to surround an outer periphery of the rotor 20, and a plurality of stator coils 11. The stator 10 may include a case surrounding the stator core, the plurality of stator coils 11, and the rotor 20. An air gap having a uniform width is formed between the stator 10 and the rotor 20. “Uniform width” does not merely mean that each width of the air gap between the stator 10 and the rotor 20 is uniform. The fact that the widths of the air gaps between the stator 10 and the rotor 20 are uniform includes the fact that the difference between the widths includes the slight difference in the predetermined range, the manufacturing error, or the measurement error. In a case where the difference between the widths includes the slight difference in the predetermined range, the fact that each width of the air gap between the stator 10 and the rotor 20 is uniform includes, for example, the fact that each width of the air gap between the stator 10 and the rotor 20 is within a range of ±10% with respect to the average width of the widths of all the air gaps. The stator core holds the plurality of stator coils 11. Each stator coil 11 is disposed on the inner peripheral side of the stator core. The plurality of stator coils 11 are arranged at equal angular intervals with respect to the rotation axis of the rotor 20.

The rotating electrical machine MT is connected to a control circuit 41. The control circuit 41 is connected to a power supply 43. The control circuit 41 adjusts a drive current from the power supply 43 and supplies a three-phase AC current to each stator coil 11. The control circuit 41 controls a value of the three-phase alternating current supplied to each stator coil 11. The control circuit 41 includes, for example, an inverter circuit. Due to supplying the three-phase AC current to each stator coil 11, each stator coil 11 forms a rotating magnetic field that rotates the rotor 20. The power supply 43 includes, for example, an electrical energy storage device. The electrical energy storage device includes, for example, a secondary battery or a capacitor.

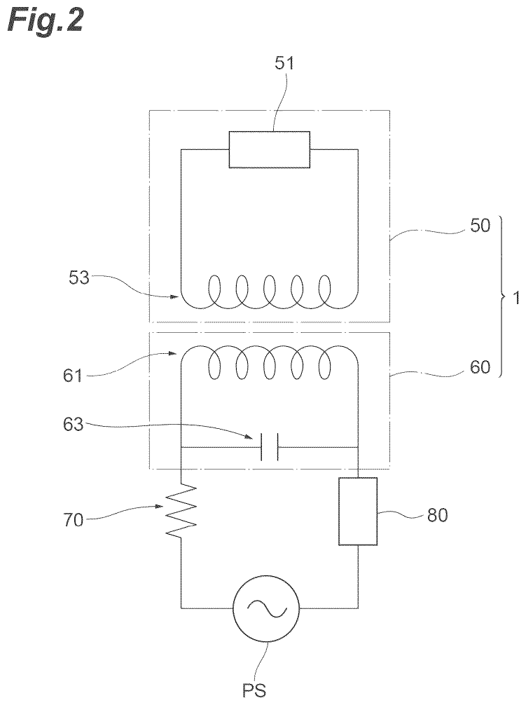

Next, the configuration of the magnet temperature information output device 1 will be described in more detail with reference to FIG. 2. FIG. 2 is a circuit diagram illustrating an example of the magnet temperature information output device.

The magnet temperature information output device 1 is arranged to output temperature information regarding a temperature of the permanent magnet 25. That is, the magnet temperature information output device 1 outputs temperature information regarding a temperature of the permanent magnet 25. In order to realize the function, the magnet temperature information output device 1 includes an element 50, an element 60, an electric resistance element 70, and an output section 80. In the present embodiment, the number of elements 50 is one, and the number of elements 60 is also one. The element 50 is provided on the rotor 20. The element 60 is provided on the stator 10. The element 60 is provided, for example, on the stator core. The element 50 and the element 60 are disposed to oppose each other in a direction parallel to the rotation axis of the rotor 20 in a state where the rotor 20 is at a predetermined rotation angle position. The “direction parallel to the rotation axis of the rotor 20” does not merely mean only the direction parallel to the rotation axis of the rotor 20. The direction parallel to the rotation axis of the rotor 20 includes a direction in which the slight difference in the predetermined range, the manufacturing error, or the measurement error is included in an angle formed with the rotation axis of the rotor 20. In a case where the slight difference in the predetermined range is included in the angle formed with the rotation axis of the rotor 20, the direction parallel to the rotation axis of the rotor 20 includes, for example, a direction in which the angle is within a range of ±2 degrees.

As illustrated in FIG. 2, the element 50 includes a temperature sensitive element 51 and a coil 53. The temperature sensitive element 51 and the coil 53 are provided on the rotor 20. The temperature sensitive element 51 is provided on at least one permanent magnet 25 among the plurality of permanent magnets 25. In the present embodiment, the temperature sensitive element 51 is provided only on one permanent magnet 25. The temperature sensitive element 51 is disposed to be in contact with the permanent magnet 25. The temperature sensitive element 51 may be disposed close to the permanent magnet 25. In the temperature sensitive element 51, electric resistance changes in response to the temperature of the permanent magnet 25. An electric resistance of the temperature sensitive element 51 decreases as the temperature of the permanent magnet 25 increases. The temperature sensitive element 51 includes, for example, a thermistor or a Hall element. The thermistor includes, for example, an NTC thermistor. The coil 53 is electrically connected to the temperature sensitive element 51. In the present embodiment, both ends of the coil 53 are electrically connected to both ends of the temperature sensitive element 51.

The element 60 includes a coil 61 and a capacitor 63. The coil 61 is disposed on the stator 10 to oppose the coil 53 in the rotation axis direction D of the rotor 20 in the state where the rotor 20 is at the predetermined rotation angle position. The coil 53 and the coil 61 are disposed to oppose each other in the rotation axis direction D of the rotor 20 in the state where the rotor 20 is at the predetermined rotation angle. The coil 61 is arranged to be magnetically coupled to the coil 53. That is, the coil 61 is magnetically coupled to the coil 53. The coil 61 is electrically connected to an AC power supply PS. The AC power supply PS includes, for example, an inverter. An AC signal having a predetermined frequency is applied from the AC power supply PS to the coil 61. An AC voltage is applied from the AC power supply PS to the coil 61. The predetermined frequency is higher than a driving frequency of the rotating electrical machine MT. The predetermined frequency is, for example, 10 to 2000 times the driving frequency of the rotating electrical machine MT. The capacitor 63 and the coil 61 form an LC resonance circuit. The capacitor 63 may form an LC resonance circuit with the coil 53 and the coil 61. The capacitor 63 is inserted, for example, to be connected in parallel to the coil 61. For example, in a configuration in which the coil 53 includes a first coil, the coil 61 includes a second coil.

Furthermore, for example, the predetermined frequency may be less than or equal to a predetermined resonance frequency for exciting the coil 53. That is, the frequency of the voltage applied to the coil 61 may be less than or equal to a predetermined resonance frequency for exciting the coil 53. The predetermined resonance frequency is, for example, a resonance frequency of a circuit equivalently indicating a circuit in the magnet temperature information output device 1 in a state where the coil 53 and the coil 61 are magnetically coupled and the temperature of the temperature sensitive element 51 is a predetermined temperature. In the present embodiment, the circuit in the magnet temperature information output device 1 is a circuit including the temperature sensitive element 51, the coil 53, the coil 61, and the capacitor 63. The predetermined temperature is, for example, room temperature. The room temperature is, for example, higher than or equal to 15° C. or lower than or equal to 30° C. In the present embodiment, the predetermined temperature is 25° C.

The electric resistance element 70 is electrically connected to the element 60. The electric resistance element 70 may be electrically connected to the coil 61. In the present embodiment, the electric resistance element 70 is provided on the stator 10 and is inserted between the coil 61 and the AC power supply PS.

The output section 80 is electrically connected to the element 60 and the electric resistance element 70. The output section 80 may be electrically connected to the coil 61. That is, the coil 61 may be electrically connected to the electric resistance element 70 and the output section 80. In the present embodiment, the output section 80 is provided on the stator 10. The output section 80 outputs an electric signal responding to the magnitude of the voltage drop occurring in the electric resistance element 70. The output section 80 may output an electric signal indicating the magnitude of the voltage drop occurring in the electric resistance element 70. The output section 80 includes, for example, a voltmeter. The voltmeter may include, for example, an arithmetic device including a central processing unit (CPU), a read only memory (ROM), and a random access memory (RAM). The arithmetic device may include, for example, a microcomputer. In this case, the voltmeter loads a program stored in the ROM into the RAM and executes the program by the CPU, thereby outputting the electric signal responding to the magnitude of the voltage drop occurring in the electric resistance element 70 described above.

A magnetic flux responding to the AC voltage applied from the AC power supply PS is generated in the coil 61. When the rotor 20 rotates and the coil 61 and the coil 53 approach each other, the magnetic flux generated in the coil 61 passes through the coil 53. When the magnetic flux generated in the coil 61 passes through the coil 53, electric power responding to a change in the magnetic flux passing through the coil 53 is generated in the coil 53. That is, when the rotor 20 rotates and the coil 61 and the coil 53 approach each other, the coil 61 and the coil 53 are magnetically coupled to each other. Alternatively, it can be said that the coil 61 excites the coil 53 and supplies electric power to the coil 53.

Since the electric resistance of the temperature sensitive element 51 changes in response to the temperature of the permanent magnet 25, the magnetic flux generated in the coil 61 changes in response to the change in the electric resistance of the temperature sensitive element 51. Therefore, a current flowing through the coil 61 changes. When the current flowing through the coil 61 changes, the magnitude of the voltage drop occurring in the electric resistance element 70 changes.

When the temperature of the permanent magnet 25 increases and the electric resistance of the temperature sensitive element 51 decreases, the magnetic flux generated in the coil 61 increases. Therefore, the current flowing through the coil 61 increases, and the magnitude of the voltage drop occurring in the electric resistance element 70 also increases. When the temperature of the permanent magnet 25 decreases and the electric resistance of the temperature sensitive element 51 increases, the magnetic flux generated in the coil 61 decreases. Therefore, the current flowing through the coil 61 decreases, and the magnitude of the voltage drop occurring in the electric resistance element 70 also decreases. That is, as the temperature of the permanent magnet 25 increases, the magnitude of the voltage drop occurring in the electric resistance element 70 increases. Similarly, as the temperature of the permanent magnet 25 decreases, the magnitude of the voltage drop occurring in the electric resistance element 70 decreases.

The output section 80 is arranged to detect the magnetic flux generated in the coil 61 as the magnitude of the voltage drop occurring in the electric resistance element 70. That is, the output section 80 is arranged to detect the magnetic flux generated in the coil 61 as the magnitude of the voltage drop occurring in the electric resistance element 70. The magnitude of the voltage drop detected by the output section 80 responds to the change in the electric resistance of the temperature sensitive element 51, that is, a change in the temperature of the permanent magnet 25. Therefore, the electric signal output from the output section 80 includes temperature information regarding the temperature of the permanent magnet 25. That is, the output section 80 is arranged to output the electric signal responding to the magnitude of the voltage drop occurring in the electric resistance element 70 as the temperature information. The output section 80 is arranged to output the electric signal responding to the magnitude of the voltage drop occurring in the electric resistance element 70 as the temperature information. As a result, the temperature information regarding the temperature of the permanent magnet 25 is wirelessly transmitted between the element 50 and the output section 80 via the element 60.

The electric signal output from the output section 80 is input to the control circuit 41 as the temperature information. The control circuit 41 is arranged to acquire the electric signal output from the magnet temperature information output device 1 and responding to the magnitude of the voltage drop occurring in the electric resistance element 70. That is, the control circuit 41 acquires the electric signal output from the magnet temperature information output device 1 and responding to the magnitude of the voltage drop occurring in the electric resistance element 70. The control circuit 41 is arranged to obtain the temperature of the permanent magnet 25 based on the acquired electric signal. That is, the control circuit 41 obtains the temperature of the permanent magnet 25 based on the acquired electric signal. In the present embodiment, the control circuit 41 functions as a magnet temperature acquisition device.

For example, the control circuit 41 obtains the temperature of the permanent magnet 25 as follows. First, the control circuit 41 refers to data indicating a relationship between the electric signal responding to the magnitude of the voltage drop occurring in the electric resistance element 70 and the temperature. The data may be stored in the control circuit 41 or may be stored in an external server different from the control circuit 41. Next, the control circuit 41 obtains the temperature responding to the acquired electric signal in the data as the temperature of the permanent magnet 25.

The control circuit 41 controls the driving state of the rotating electrical machine MT based on the obtained temperature of the permanent magnet 25. For example, the control circuit 41 controls the driving state of the rotating electrical machine MT in the following manner. In a case where the control circuit 41 determines that the obtained temperature of the permanent magnet 25 has increased to a predetermined first threshold value, the control circuit 41 controls a supply electric power to limit a rotational speed of the rotating electrical machine MT. In a case where the control circuit 41 determines that the obtained temperature of the permanent magnet 25 has decreased to a predetermined second threshold value smaller than the first threshold value, the control circuit 41 controls the supply electric power to release the limitation on the rotational speed of the rotating electrical machine MT.

The control circuit 41 may control the driving state of the rotating electrical machine MT as follows. That is, the control circuit 41 may control the driving frequency to be input to the rotating electrical machine MT, for example, based on the obtained temperature of the permanent magnet 25. In the case where the control circuit 41 determines that the obtained temperature of the permanent magnet 25 has increased to the predetermined first threshold value, the control circuit 41 performs a control to reduce the driving frequency to limit the rotational speed of the rotating electrical machine MT. In the case where the control circuit 41 determines that the obtained temperature of the permanent magnet 25 has decreased to the predetermined second threshold value smaller than the first threshold value, the control circuit 41 performs a control to increase the driving frequency to release the limitation on the rotational speed of the rotating electrical machine MT.

The control circuit 41 includes, for example, a central processing unit (CPU), a read only memory (ROM), and a random access memory (RAM). For example, the control circuit 41 loads a program stored in the ROM into the RAM and executes the program by the CPU, thereby obtaining the temperature of the permanent magnet 25 and controlling the driving state of the rotating electrical machine MT described above.

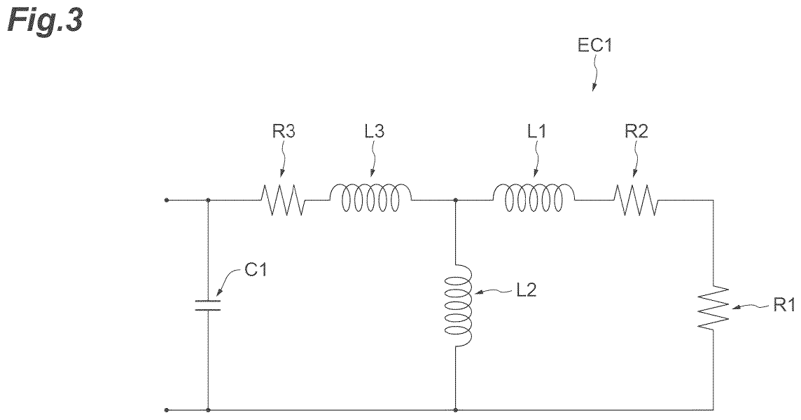

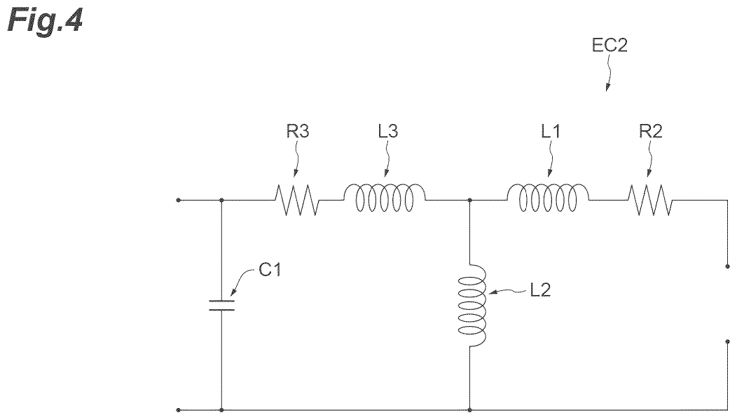

Next, the electric resistance of the electric resistance element 70 will be described with reference to FIGS. 3 and 4. FIGS. 3 and 4 are circuit diagrams illustrating an equivalent circuit used for setting the electric resistance of the electric resistance element.

As described above, the electric resistance of the temperature sensitive element 51 changes in response to the temperature of the permanent magnet 25. In response to the change in the electric resistance of the temperature sensitive element 51, a range of the electric resistance of the electric resistance element 70 that accurately detects the change in the temperature of the permanent magnet 25 also changes. In the present embodiment, the electric resistance of the electric resistance element 70 is set in the range in which the change in the temperature of the permanent magnet 25 is accurately detected.

Hereinafter, the range of the electric resistance of the electric resistance element 70, which accurately detects the change in the temperature of the permanent magnet 25, is referred to as “a first range of the electric resistance of the electric resistance element 70”, and a range of the electric resistance of the electric resistance element 70, which more accurately detects the change in the temperature of the permanent magnet 25, is referred to as “a second range of the electric resistance of the electric resistance element 70”. Furthermore, hereinafter, the electric resistance of the electric resistance element 70, which more reliably and accurately detects the change in the temperature of the permanent magnet 25 may be referred to as “first electric resistance of the electric resistance element 70”.

An impedance of the entire magnet temperature information output device 1 including the element 50 and the element 60 also changes in response to the change in the electric resistance of the temperature sensitive element 51. That is, a combined impedance of the element 50 and the element 60 also changes in response to the change in the electric resistance of the temperature sensitive element 51. Therefore, the present inventors focused on a relationship between the first range of the electric resistance of the electric resistance element 70 and the combined impedance of the element 50 and the element 60. In order to clarify the relationship between the first range of the electric resistance of the electric resistance element 70 and the combined impedance of the element 50 and the element 60, the present inventors conducted an experiment using an equivalent circuit EC1 illustrated in FIG. 3. The equivalent circuit EC1 is a circuit equivalently representing a circuit including the temperature sensitive element 51, the coil 53, the coil 61, and the capacitor 63 in the magnet temperature information output device 1. Therefore, the equivalent circuit EC1 includes elements corresponding to the temperature sensitive element 51, the coil 53, the coil 61, and the capacitor 63.

In the present embodiment, as illustrated in FIG. 3, the equivalent circuit EC1 includes an element R1, elements L1 and R2, an element L2, elements L3 and R3, and an element C1. The element R1 corresponds to the temperature sensitive element 51. In the present embodiment, the element R1 includes an element corresponding to the electric resistance of the temperature sensitive element 51. The elements L1 and R2 correspond to the coil 53. In the present embodiment, the element L1 includes an element corresponding to inductance of the coil 53, and the element R2 includes an element corresponding to electric resistance of the coil 53. In the equivalent circuit EC1, the element R1 and the elements L1 and R2 are electrically connected.

The elements L3 and R3 correspond to the coil 61. In the present embodiment, the element L3 includes an element corresponding to inductance of the coil 61, and the element R3 includes an element corresponding to electric resistance of the coil 61. The element R3 is connected in series to the element L3. The element L2 corresponds to magnetic coupling between the coil 53 and the coil 61. In the present embodiment, the element L3 includes an element corresponding to the mutual inductance between the coil 53 and the coil 61. The element C1 corresponds to the capacitor 63. In the present embodiment, the element C1 includes an element corresponding to a capacitance of the capacitor 63. The element C1 is connected in parallel to the element L3. In the equivalent circuit EC1, an end closer to the element C1 is opened. In the equivalent circuit EC1, a portion including the element R1 and the elements R2 and L1 corresponds to the element 50, and a portion including the elements L3 and R3 and the element C1 corresponds to the element 60.

The present inventors obtained, while changing a temperature of the element R1 corresponding to the temperature sensitive element 51, a relationship between the impedance in the equivalent circuit EC1 at the temperature and the first range of the electric resistance of the electric resistance element 70 when the temperature sensitive element 51 is at the temperature. The present inventors obtained, while changing the temperature of the element R1 corresponding to the temperature sensitive element 51, a relationship between the impedance in the equivalent circuit EC1 at the temperature and the second range of the electric resistance of the electric resistance element 70 when the temperature sensitive element 51 is at the temperature. The present inventors obtained, while changing a temperature of the element R1 corresponding to the temperature sensitive element 51, a relationship between the impedance in the equivalent circuit EC1 at the temperature and the first electric resistance of the electric resistance element 70 when the temperature sensitive element 51 is at the temperature. As a result, the present inventors found that the first range of the electric resistance of the electric resistance element 70 is greater than or equal to a×Z1_{T}^{0.28} and less than or equal to a×Z1_{T}^{0.71}, Z1_{T} is a combined impedance of the element 50 and the element 60 in the equivalent circuit EC1 when the temperature of the element R1 is T° C. The present inventors found that the second range of electric resistance of the electric resistance element 70 is greater than or equal to a×Z_{T}^{0.38} and less than or equal to a×Z1_{T}^{0.63}. The present inventors found that the first electric resistance of the electric resistance element 70 is a×Z1_{T}^{0.50}. Here, “a” indicates a proportional coefficient set for each circuit.

Next, the present inventors conducted an investigation study for calculating the proportional coefficient a. As a result, the present inventors found that the proportional coefficient a is equal to the combined impedance of the element 50 and the element 60, without the temperature sensitive element 51 included in the element 50. Therefore, the present inventors obtained a combined impedance Z2 of the element 50 and the element 60 in the equivalent circuit EC2 illustrated in FIG. 4, and calculated the proportional coefficient a based on the combined impedance Z2. The equivalent circuit EC2 is a circuit equivalently representing a circuit including the coil 53, the coil 61, and the capacitor 63, without the temperature sensitive element 51, in the magnet temperature information output device 1. In the equivalent circuit EC2, the element R1 included in the equivalent circuit EC1 and corresponding to the temperature sensitive element 51 is opened. Therefore, in the equivalent circuit EC2, the proportional coefficient a and the combined impedance Z2 satisfy the relational expression Z2=a×Z2^{0.50}. That is, the proportional coefficient a is expressed as Z2^{0.50} using the combined impedance Z2. From the above, in the magnet temperature information output device 1, it is understood that the first range of the electric resistance of the electric resistance element 70 is greater than or equal to Zₒ^{0.50}×Z_{T}^{0.28} and less than or equal to 7₀^{0.50}×Z_{T}^{0.71}. “Zₒ” is a combined impedance of the element 50 and the element 60, without the temperature sensitive element 51 included in the element 50. In the magnet temperature information output device 1, it is understood that the second range of the electric resistance is greater than or equal to Zₒ^{0.50}×Z_{T}^{0.38} and less than or equal to Zₒ^{0.50}×Z_{T}^{0.63}. In the magnet temperature information output device 1, it is understood that the first electric resistance of the electric resistance element 70 is Zₒ^{0.50}×Z_{T}^{0.50}.

The temperature T is set based on, for example, a temperature range of the permanent magnet 25 when the rotating electrical machine MT is used. In the present embodiment, the temperature range of the permanent magnet 25 is higher than or equal to 120° C. and lower than or equal to 170° C., and the temperature T is set to T=150. Therefore, in the present embodiment, the range of the electric resistance of the electric resistance element 70 may be set to greater than or equal to Zₒ^{0.50}×Z₁₅₀^{0.28} and less than or equal to Zₒ^{0.50}×Z₁₅₀^{0.71}. That is, in the present embodiment, the electric resistance element 70 may have an electric resistance of greater than or equal to Zₒ^{0.50}×Z₁₅₀^{0.28} and less than or equal to Zₒ^{0.50}×Z₁₅₀^{0.71}. Alternatively, the electric resistance element 70 may have an electric resistance of greater than or equal to Zₒ^{0.50}×Z¹⁵⁰_{0.38} and less than or equal to Zₒ^{0.50}×Z₁₅₀^{0.63}.

A combined impedance Z1_{T} obtained in the equivalent circuit EC1 may be used as the combined impedance Z_{T}. As the combined impedance Z_{T}, actual measurement value of the combined impedance of the element 50 and the element 60 in a state where the coil 53 and the coil 61 are magnetically coupled and the temperature of the temperature sensitive element 51 is T° C. may be used. As the combined impedance Z₁₅₀, a combined impedance Z1₁₅₀ obtained in the equivalent circuit EC1 may be used. As the combined impedance Z₁₅₀, actual measurement value of the combined impedance of the element 50 and the element 60 in a state where the coil 53 and the coil 61 are magnetically coupled and the temperature of the temperature sensitive element 51 is 150° C. may be used. Similarly, a combined impedance Z2 obtained in the equivalent circuit EC2 may be used as the combined impedance Zₒ. As the combined impedance Zₒ, actual measurement value of the combined impedance of the element 50 and the element 60 in a state where the coil 53 and the coil 61 are magnetically coupled, without the temperature sensitive element 51 included in the element 50 may be used.

The actual measurement value of the combined impedance of the

element 50 and the element 60 in the state where the coil 53 and the coil 61 are magnetically coupled and the temperature of the temperature sensitive element 51 is T° C. is measured, for example, in the following manner. First, in a state where the coil 53 and the coil 61 are magnetically coupled, a relative position between the element 50 and the element 60 is maintained. Next, the temperature sensitive element 51 is heated to T° C. In a case where the actual measurement value is measured when the temperature of the temperature sensitive element 51 is 150° C., the temperature sensitive element 51 is heated to 150° C. Next, the combined impedance of the element 50 and the element 60 is measured. Note that the combined impedance of the element 50 and the element 60 may be measured without the electric resistance element 70 and the output section 80 electrically connected to the element 60.

In the state where the coil 53 and the coil 61 are magnetically coupled, without the temperature sensitive element 51 included in the element 50, actual measurement value of the combined impedance of the element 50 and the element 60 are measured, for example, in the following manner. First, in the state where the coil 53 and the coil 61 are magnetically coupled, the relative position between the element 50 and the element 60 is maintained. Next, the temperature sensitive element 51 is removed from the element 50. Next, the combined impedance of the element 50 and the element 60 is measured. Note that the combined impedance of the element 50 and the element 60 may be measured without the electric resistance element 70 and the output section 80 electrically connected to the element 60.

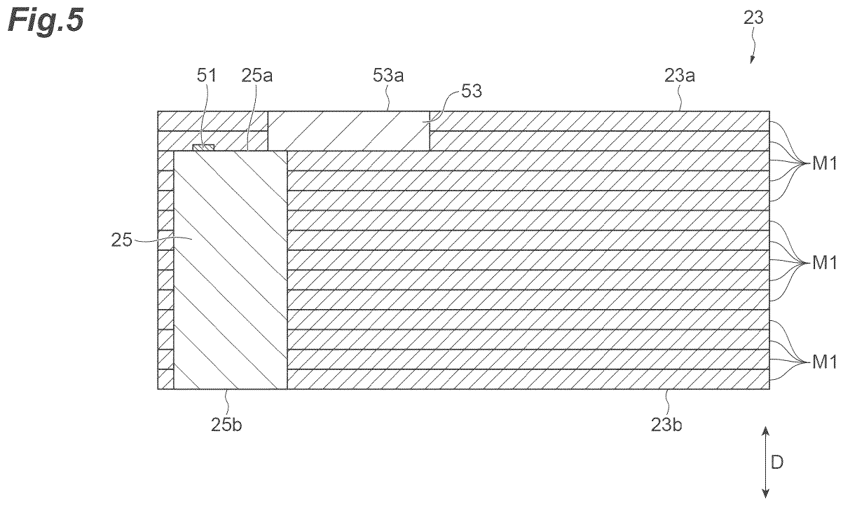

Next, an arrangement of the permanent magnet 25, the temperature sensitive element 51, and the coil 53 will be described in more detail with reference to FIG. 5. FIG. 5 is a diagram illustrating a cross-sectional configuration of a rotor core.

The rotor core 23 includes a pair of end surfaces 23a and 23b and one side surface. The end surface 23a is closer to the element 60. That is, the end surface 23a is closer to the coil 61. The end surface 23b is located on the side opposite to the end surface 23a in the rotation axis direction D. That is, the pair of end surfaces 23a and 23b are perpendicular to the rotation axis direction D and face in opposite directions to each other.

“The pair of end surfaces 23a and 23b are perpendicular to the rotation axis direction D” does not necessarily only mean that the pair of end surfaces 23a and 23b are perpendicular to the rotation axis direction D. The fact that the pair of end surfaces 23a and 23b are perpendicular to the rotation axis direction D includes that the slight difference in the predetermined range, the manufacturing error, or the measurement error is included in an angle formed by the pair of end surfaces 23a and 23b and the rotation axis direction D. In a state where the slight difference in the predetermined range is included in the angle formed by the pair of end surfaces 23a and 23b and the rotation axis direction D, the fact that the pair of end surfaces 23a and 23b are perpendicular to the rotation axis direction D includes, for example, that the angle is within a range of ±1 degree from the perpendicular.

As illustrated in FIG. 5, the rotor core 23 is formed through stacking a plurality of steel sheets M1 in the rotation axis direction D. The rotor core 23 includes the plurality of steel sheets M1 stacked in the rotation axis direction D. The steel sheet M1 has magnetism. The steel sheet M1 includes, for example, a silicon steel sheet. In the present embodiment, the steel sheet M1 closest to the coil 61 among the plurality of steel sheets M1 includes the end surface 23a as a surface thereof.

The permanent magnet 25 is positioned in the rotor core 23. In the present embodiment, as illustrated in FIG. 5, the entire permanent magnet 25 is positioned in the rotor core 23. The permanent magnet 25 includes a pair of surfaces 25a and 25b and four side surfaces. The surface 25a is closer to the coil 61. The surface 25b is located on the opposite side in the rotation axis direction D with respect to the surface 25a. That is, the pair of surfaces 25a and 25b are perpendicular to the rotation axis direction D and face in directions opposite to each other. “The pair of surfaces 25a and 25b are perpendicular to the rotation axis direction D” does not necessarily only mean that the pair of surfaces 25a and 25b are perpendicular to the rotation axis direction D. The fact that the pair of surfaces 25a and 25b are perpendicular to the rotation axis direction D includes the fact that the slight difference in the predetermined range, the manufacturing error, or the measurement error is included in an angle formed by the pair of surfaces 25a and 25b and the rotation axis direction D. In a case where the slight difference in the predetermined range is included in the angle formed by the pair of surfaces 25a and 25b and the rotation axis direction D, the fact that the pair of surfaces 25a and 25b are perpendicular to the rotation axis direction D includes, for example, that the angle is within a range of ±2 degree from the perpendicular.

The temperature sensitive element 51 is disposed to be in contact with the permanent magnet 25. The temperature sensitive element 51 is disposed on the surface 25a of the permanent magnet 25. In the present embodiment, the temperature sensitive element 51 is in contact with the surface 25a of the permanent magnet 25. In the present embodiment, similarly to the permanent magnet 25, the entire temperature sensitive element 51 is disposed in the rotor core 23.

Similarly to the permanent magnet 25, the coil 53 is also positioned in the rotor core 23. In the present embodiment, at least a part of the coil 53 is positioned in the rotor core 23. The coil 53 is closer to the end surface 23a than the permanent magnet 25 in the rotor core 23. An end 53a of the coil 53 in the rotation axis direction D is exposed from the rotor core 23. The end 53a is exposed to the end surface 23a of the rotor core 23. In the present embodiment, only end 53a of the coil 53 is exposed from the rotor core 23, and a remaining portion of the coil 53 is buried in the rotor core 23. As illustrated in FIG. 5, in the present embodiment, the end surface 23a is on the same plane as the end 53a of the coil 53. The fact that “the end surface 23a is on the same plane as the end 53a” also includes, for example, that a step difference of less than or equal to 1% of the length of the rotor 20 in the rotation axis direction D is generated between the end surface 23a and the end 53a. At least the part of the coil 53 may be positioned in the rotor core 23, and a portion other than the end 53a may be exposed from the rotor core 23. In this case, for example, a portion of a side portion of the coil 53 located closer to the end 53a may be exposed from the rotor core 23, and the end surface 23a may not be on the same planes as the end 53a.

As described above, the magnet temperature information output device 1 includes the electric resistance element 70 electrically connected to the element 60. Since the coil 61 included in the element 60 is arranged to be magnetically coupled to the coil 53, electric power is supplied to the coil 53. Since the electric resistance of the temperature sensitive element 51 electrically connected to the coil 53 changes in response to the temperature of the permanent magnet 25, the current flowing through the coil 61 changes in response to the change in the electric resistance of the temperature sensitive element 51. When the current flowing through the coil 61 changes, the magnitude of the voltage drop occurring in the electric resistance element 70 also changes. The output section 80 is arranged to output the electric signal in response to the magnitude of the voltage drop occurring in the electric resistance element 70. Therefore, the electric signal output from the output section 80 changes in response to the temperature of the permanent magnet 25. That is, in the magnet temperature information output device 1, the temperature information regarding the temperature of the permanent magnet 25 is output from the output section 80 as an electric signal related to a voltage. As described above, the magnet temperature information output device 1 outputs the temperature information regarding the temperature of the permanent magnet 25 as the electric signal related to the voltage.

Since the magnet temperature information output device 1 described above is provided in the rotating electrical machine MT, the temperature information regarding the temperature of the permanent magnet 25 is output as the electric signal related to the voltage.

Since the control circuit 41 functioning as the magnet temperature acquisition device includes the magnet temperature information output device 1, the temperature of the permanent magnet 25 is obtained based on the electric signal related to the voltage.

In the magnet temperature information output device 1, the electric resistance element 70 has the electric resistance of greater than or equal to Zₒ^{0.50}×Z₁₅₀^{0.28} and less than or equal to Zₒ^{0.50}×Z₁₅₀^{0.71}.

The electric resistance of greater than or equal to Zₒ^{0.50}×Z₁₅₀^{0.28} and less than or equal to Zₒ^{0.50}×Z₁₅₀^{0.71} is the range of the electric resistance of the electric resistance element 70 that accurately detects the change in the temperature of the permanent magnet 25 as described above. Therefore, the magnet temperature information output device 1 accurately outputs the temperature information regarding the temperature of the permanent magnet 25.

The magnet temperature information output device 1 includes the capacitor 63 that is provided on the stator 10 and forms the LC resonance circuit together with the coil 61.

The magnet temperature information output device 1 accurately detects the change in the electric resistance of the temperature sensitive element 51. Therefore, the magnet temperature information output device 1 accurately outputs the temperature information regarding the temperature of the permanent magnet 25.

In the rotating electrical machine MT, the coil 53 and the coil 61 are disposed to oppose each other in the rotation axis direction D of the rotor 20 in the state where the rotor 20 is at the predetermined rotation angle position.

In the rotating electrical machine MT, the magnetic flux generated in the stator coil 11 is less likely to affect the coil 53 and the coil 61.

In a case where the temperature information regarding the temperature of the permanent magnet 25 is output, a configuration can be considered in which an electric signal related to the current flowing through the coil 61 can be output as the temperature information without providing the electric resistance element 70 in the stator 10. In this configuration, when the electric signal related to the current is acquired and the temperature of the permanent magnet 25 is obtained based on the electric signal, it is necessary to convert the acquired electric signal related to the current into the electric signal related to the voltage in the magnet temperature acquisition device. Since the magnet temperature information output device 1 includes the electric resistance element 70, the electric signal related to the voltage is output as the temperature information regarding the temperature of the permanent magnet 25. Therefore, in the control circuit 41 functioning as the magnet temperature acquisition device, it is not necessary to convert the electric signal related to the current into the electric signal related to the voltage. As described above, the magnet temperature information output device 1 outputs the temperature information that easily and conveniently obtains the temperature of the permanent magnet 25.

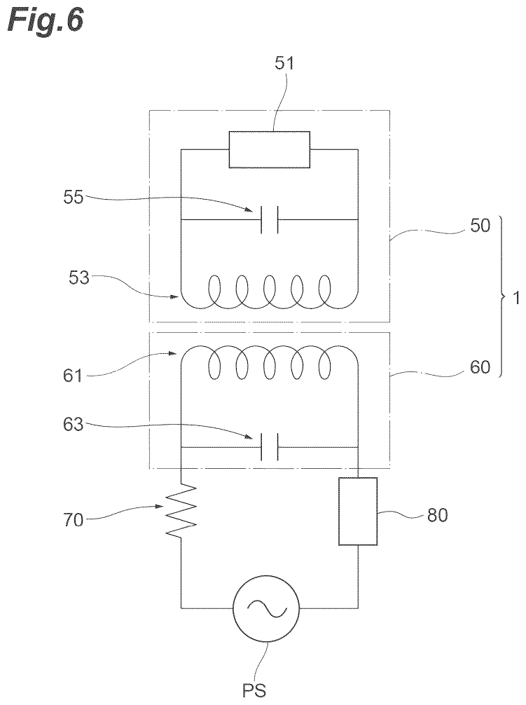

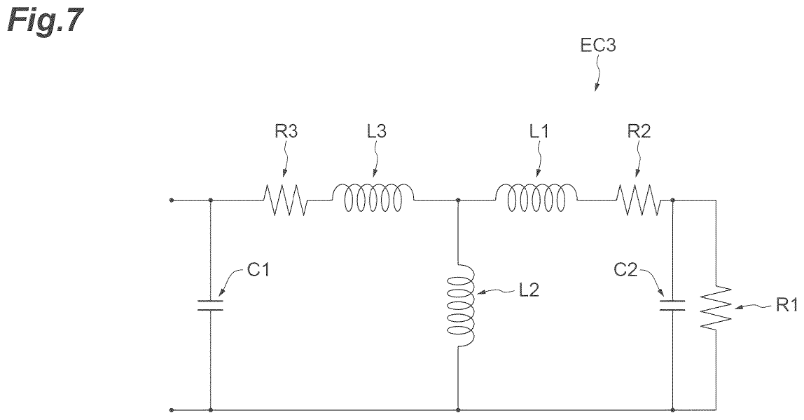

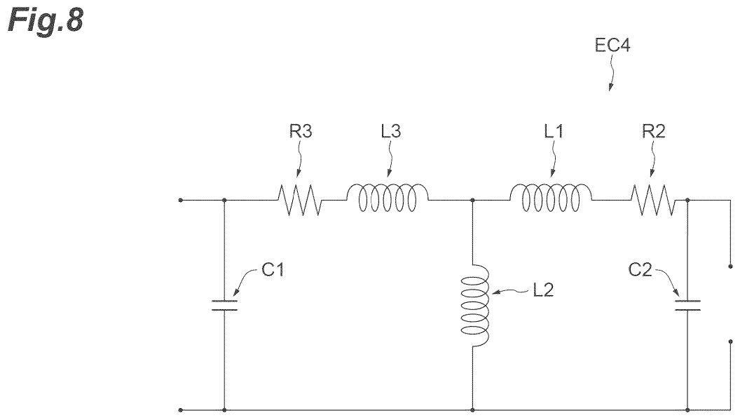

Next, a configuration of a modification of the magnet temperature information output device 1 will be described with reference to FIGS. 6, 7, and 8. FIG. 6 is a circuit diagram illustrating another example of the magnet temperature information output device. FIGS. 7 and 8 are circuit diagrams illustrating an equivalent circuit used for setting the electric resistance of the electric resistance element. In the present modification, the configuration of the element 50 is different from that of the above-described embodiment. Hereinafter, differences between the above-described embodiment and the present modification will be mainly described.

In the present modification, as illustrated in FIG. 6, the element 50 includes the temperature sensitive element 51, the coil 53, and a capacitor 55. The capacitor 55 and the coil 53 form the LC resonance circuit. The capacitor 55 may form the LC resonance circuit with the coil 53 and the coil 61. The capacitor 55 is inserted, for example, to be connected in parallel to the coil 53. A capacitance of the capacitor 55 may be equal to the capacitance of the capacitor 63 or may be different from the capacitance of the capacitor 63. In a configuration in which the capacitance of the capacitor 55 and the capacitance of the capacitor 63 are different from each other, the capacitance of the capacitor 55 may be greater than or equal to 30% and less than or equal to 200% of the capacitance of the capacitor 63, or may be greater than or equal to 70% and less than or equal to 130% of the capacitance of the capacitor 63. The capacitor 55 may have, for example, a capacitance of less than or equal to 100 nF, or a capacitance of greater than or equal to 1 nF and less than or equal to 100 nF. The capacitance of the capacitor 55 is not limited to the above range. The capacitance of the capacitor 55 may be less than 1 nF or greater than 100 nF.

As described above, the magnetic flux responding to the applied AC voltage is generated in the coil 61. Then, when the rotor 20 rotates and the coil 61 and the coil 53 approach each other, the coil 61 excites the coil 53. In the present modification, the coil 61 is arranged to be applied with a voltage having a frequency smaller than the predetermined resonance frequency for exciting the coil 53. That is, the coil 61 is applied with the voltage having the frequency smaller than the predetermined resonance frequency for exciting the coil 53. As described above, the predetermined resonance frequency is, for example, the resonance frequency of the circuit equivalently indicating the circuit in the magnet temperature information output device 1 in the state where the coil 53 and the coil 61 are magnetically coupled and the temperature of the temperature sensitive element 51 is the predetermined temperature. In the present modification, the circuit is a circuit including the temperature sensitive element 51, the coil 53, the coil 61, the capacitor 55, and the capacitor 63. Hereinafter, the “the resonance frequency of the circuit equivalently indicating the circuit in the magnet temperature information output device 1 in the state where the coil 53 and the coil 61 are magnetically coupled and the temperature of the temperature sensitive element 51 is the predetermined temperature” may be referred to as a reference resonance frequency. In the present modification, a difference between the frequency of the voltage applied to the coil 61 and the predetermined resonance frequency is greater than or equal to 5 kHz and less than or equal to 30 KHz.

In the present modification, an equivalent circuit EC3 illustrated in FIG. 7 and an equivalent circuit EC4 illustrated in FIG. 8 may be used when obtaining the combined impedances Z_{T} and Zₒ.

The equivalent circuit EC3 is a circuit equivalently representing a circuit including the temperature sensitive element 51, the coil 53, the capacitor 55, the coil 61, and the capacitor 63 in the magnet temperature information output device 1 in which the element 50 has the configuration described above. Therefore, the equivalent circuit EC3 includes elements corresponding to the temperature sensitive element 51, the coil 53, the capacitor 55, the coil 61, and the capacitor 63. In the present modification, as illustrated in FIG. 7, the equivalent circuit EC3 includes the element R1, the elements L1 and R2, an element C2, the element L2, the elements L3 and R3, and the element C1. The element C2 corresponds to the capacitor 55. In the present modification, the element C2 includes an element corresponding to a capacitance of the capacitor 55.

Also in the equivalent circuit EC3, the element R3 is connected in series to the element L3. The element C1 is connected in parallel to the element L3. The element C2 is connected in parallel to the element L1. In the equivalent circuit EC3, the end closer to the element C1 is opened. In the equivalent circuit EC3, a portion including the element R1, the elements R2 and L1, and the element C2 corresponds to the element 50, and the portion including the elements L3 and R3 and the element C1 corresponds to the element 60.

The equivalent circuit EC4 is a circuit equivalently representing a circuit including the coil 53, the capacitor 55, the coil 61, and the capacitor 63, without the temperature sensitive element 51, in the magnet temperature information output device 1 in which the element 50 includes the temperature sensitive element 51, the coil 53, and the capacitor 55. In the equivalent circuit EC4, the element R1 included in the equivalent circuit EC3 and corresponding to the temperature sensitive element 51 is opened.

In the present modification, a combined impedance Z3_{T} obtained in the equivalent circuit EC3 may be used as the combined impedance Z_{T}. The combined impedance Z3_{T} is a combined impedance of the element 50 and the element 60 in the equivalent circuit EC3 when the temperature of the element R1 is T° C. As the combined impedance Z₁₅₀, a combined impedance Z3₁₅₀ obtained in the equivalent circuit EC3 may be used. Similarly, a combined impedance Z4 obtained in the equivalent circuit EC4 may be used as the combined impedance Zₒ. The combined impedance Z4 is a combined impedance of the element 50 and the element 60 in the equivalent circuit EC4.

In the present modification, as described above, the combined impedance Z3_{T} may be used as the combined impedance Z_{T}, and the combined impedance Z4 may be used as the combined impedance Zₒ. Therefore, in the present modification, the first range of the electric resistance, the second range of the electric resistance, and the first electric resistance of the electric resistance element 70 may be set using the combined impedance Z3_{T} and the combined impedance Z4.

In the present modification, the element 50 includes the capacitor 55. In this case, the magnet temperature information output device 1 accurately detects the change in the electric resistance of the temperature sensitive element 51. Therefore, the magnet temperature information output device 1 accurately outputs the temperature information regarding the temperature of the permanent magnet 25.

In a configuration in which the capacitance of the capacitor 55 is equal to the capacitance of the capacitor 63, the magnet temperature information output device 1 accurately outputs the temperature information regarding the temperature of the permanent magnet 25.

As described above, in the present modification, the magnet temperature information output device 1 accurately outputs the temperature information regarding the temperature of the permanent magnet 25. Hereinafter, a relationship between the present modification and accurately outputting the temperature information regarding the temperature of the permanent magnet 25 will be described in more detail.

In the present modification, the magnet temperature information output device 1 detects the change in the electric resistance of the temperature sensitive element 51 with higher accuracy. For example, in the configuration in which the element 60 includes the capacitor 63 and the element 50 includes the capacitor 55, the change in the electric resistance of the temperature sensitive element 51 is accurately detected as compared with a configuration in which the element 60 includes the capacitor 63 and the element 50 does not include the capacitor 55.

The inductance of the coils 53 and 61 and the capacitance of the capacitors 55 and 63 have design values. However, these values may be deviated from the design values due to, for example, the manufacturing error. A coupling constant between the coil 53 and the coil 61 also has a design value. However, this value may be deviated from the design value due to, for example, a deviation in the opposing distance between the coil 53 and the coil 61. The deviation in the opposing distance between the coil 53 and the coil 61 is caused by, for example, an installation error when the coil 53 and the coil 61 are installed.

In a case where the deviation from the design value described above occurs, a variation may occur in the electric signal responding to the magnitude of the voltage drop occurring in the electric resistance element 70, output as the temperature information. The variation in the electric signal affects accuracy of the temperature information. For example, as the variation of the electric signal is smaller, the accuracy of the temperature information is improved. On the other hand, it is difficult to eliminate the manufacturing error and the installation error. Therefore, it is desired to reduces the variation of the electric signal even in the case where the deviation from the design value described above occurs due to the manufacturing error and the installation error.

In the present modification, even if the inductance of each of the coils 53 and 61, the capacitance of each of the capacitors 55 and 63, and the coupling constant between the coil 53 and the coil 61 are deviated from the design values, the variation in electric signal are reduced. In the present modification, for example, the variation in the electric signal are reduced in the temperature range of the permanent magnet 25 when the rotating electrical machine MT is used.

As described above, in the configuration in which the element 60 includes the capacitor 63 and the element 50 includes the capacitor 55, the magnet temperature information output device 1 accurately outputs the temperature information regarding the temperature of the permanent magnet 25.

In the present modification, the coil 61 is arranged to be applied with the voltage having the frequency smaller than the predetermined resonance frequency for exciting the coil 53. In the present modification, the coil 61 is arranged to be applied with an AC voltage having a frequency smaller than the predetermined frequency as the voltage having the frequency smaller than the predetermined resonance frequency for exciting the coil 53.

In the configuration in which the coil 61 is arranged to be applied with the voltage having the frequency smaller than the predetermined resonance frequency for exciting the coil 53, the magnet temperature information output device 1 accurately outputs the temperature information regarding the temperature of the permanent magnet 25.

In the present modification, the coil 61 is arranged to be applied with the voltage having the frequency smaller than the predetermined resonance frequency for exciting the coil 53. In the present modification, the coil 61 is arranged to be applied with an AC voltage having a frequency smaller than the predetermined frequency as the voltage having the frequency smaller than the predetermined resonance frequency for exciting the coil 53. The difference between the frequency and the predetermined resonance frequency is greater than or equal to 5 kHz and less than or equal to 30 KHz.

In the present modification, even if the coupling constant between the coil 53 and the coil 61 is deviates from the design value, the variation in the electric signal is further reduced. In the present modification, for example, the variation in the electric signal are further reduced in the temperature range of the permanent magnet 25 when the rotating electrical machine MT is used. Therefore, in the configuration in which the coil 61 is arranged to be applied with the voltage having the frequency smaller than the predetermined resonance frequency for exciting the coil 53 and the difference between the frequency and the predetermined resonance frequency is greater than or equal to 5 kHz and less than or equal to 30 kHz, the magnet temperature information output device 1 accurately outputs the temperature information regarding the temperature of the permanent magnet 25.

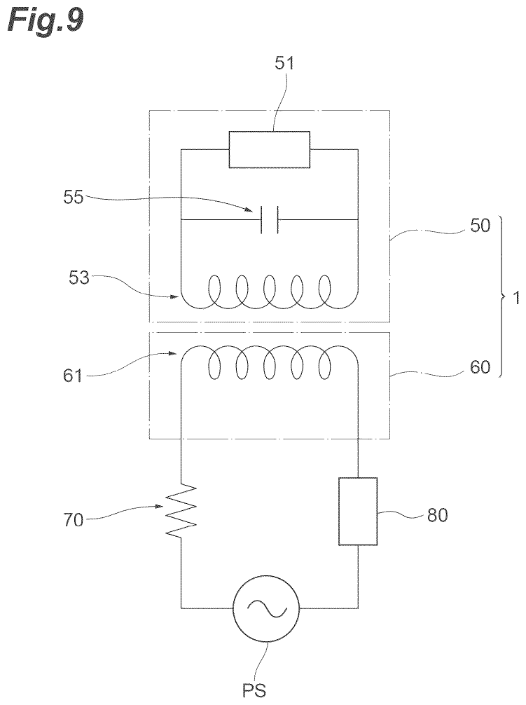

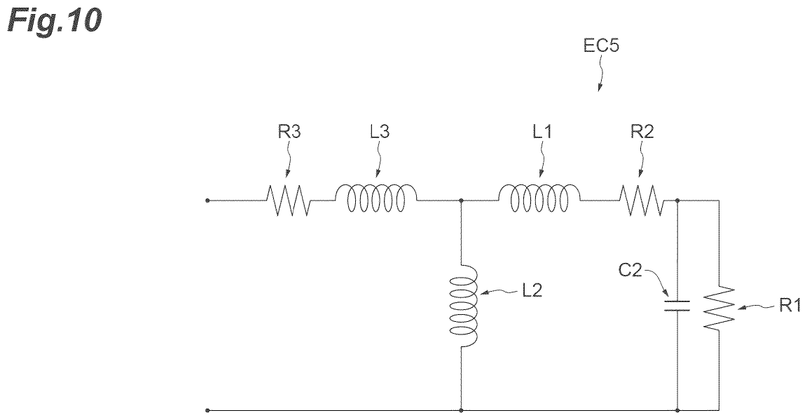

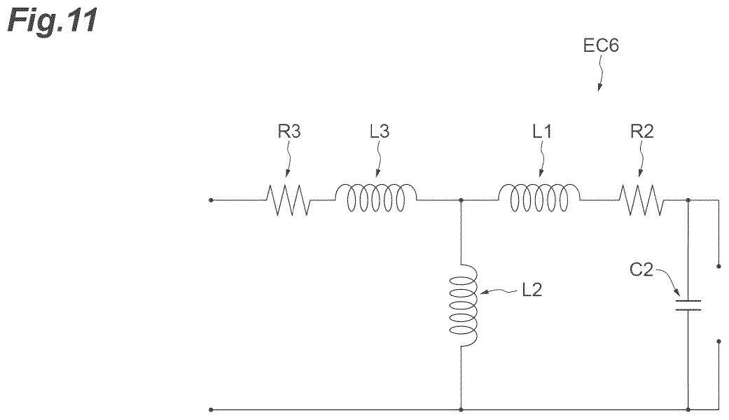

Next, a configuration of another modification of the magnet temperature information output device 1 will be described with reference to FIGS. 9, 10, and 11. FIG. 9 is a circuit diagram illustrating still another example of the magnet temperature information output device. FIGS. 10 and 11 are circuit diagrams illustrating an equivalent circuit used for setting the electric resistance of the electric resistance element. In the present modification, the configuration of the element 50 and the configuration of the element 60 are different from that of the above-described embodiment. Hereinafter, differences between the above-described embodiment and the present modification will be mainly described.

In the present modification, as illustrated in FIG. 9, the element 50 includes the temperature sensitive element 51, the coil 53, and a capacitor 55, and the element 60 does not include the capacitor 63.

In the present modification, an equivalent circuit EC5 illustrated in FIG. 10 and an equivalent circuit EC6 illustrated in FIG. 11 may be used when obtaining the combined impedances Z_{T} and Zₒ.

The equivalent circuit EC5 is a circuit equivalently representing a circuit including the temperature sensitive element 51, the coil 53, the capacitor 55, and the coil 61 in the magnet temperature information output device 1 in which the element 50 and the element 60 have the configuration described above. Therefore, the equivalent circuit EC5 includes elements corresponding to the temperature sensitive element 51, the coil 53, the capacitor 55, and the coil 61. In the present modification, as illustrated in FIG. 10, the equivalent circuit EC5 includes the element R1, the elements L1 and R2, the element C2, the element L2, and the elements L3 and R3.

Also in the equivalent circuit EC5, the element R3 is connected in series to the element L2. The element C2 is connected in parallel to the element L1. In the equivalent circuit EC5, an end closer to the elements L3 and R3 is opened. In the equivalent circuit EC5, the portion including the element R1, the elements R2 and L1, and the element C2 corresponds to the element 50, and a portion including the elements L3 and R3 corresponds to the element 60.

The equivalent circuit EC6 is a circuit equivalently representing a circuit including the coil 53, the capacitor 55, and the coil 61, without the temperature sensitive element 51 in the magnet temperature information output device 1 in which the element 50 and the element 60 have the configuration described above. In the equivalent circuit EC6, the element R1 included in the equivalent circuit EC5 and corresponding to the temperature sensitive element 51 is opened.

In the present modification, a combined impedance Z5_{T} obtained in the equivalent circuit EC5 may be used as the combined impedance Z_{T}. The combined impedance Z5_{T} is a combined impedance of the element 50 and the element 60 in the equivalent circuit EC5 when the temperature of the element R1 is T° C. As the combined impedance Z₁₅₀, a combined impedance Z5₁₅₀ obtained in the equivalent circuit EC5 may be used. Similarly, a combined impedance Z6 obtained in the equivalent circuit EC6 may be used as the combined impedance Zₒ. The combined impedance Z6 is a combined impedance of the element 50 and the element 60 in the equivalent circuit EC6.

In the present modification, as described above, the combined impedance Z5_{T} may be used as the combined impedance Z_{T}, and the combined impedance Z6 may be used as the combined impedance Zₒ. Therefore, in the present modification, the first range of the electric resistance, the second range of the electric resistance, and the first electric resistance of the electric resistance element 70 may be set using the combined impedance Z5_{T} and the combined impedance Z6.

In the present modification, the element 50 includes the capacitor 55. In this case, the magnet temperature information output device 1 accurately detects the change in the electric resistance of the temperature sensitive element 51. Therefore, the magnet temperature information output device 1 accurately outputs the temperature information regarding the temperature of the permanent magnet 25.

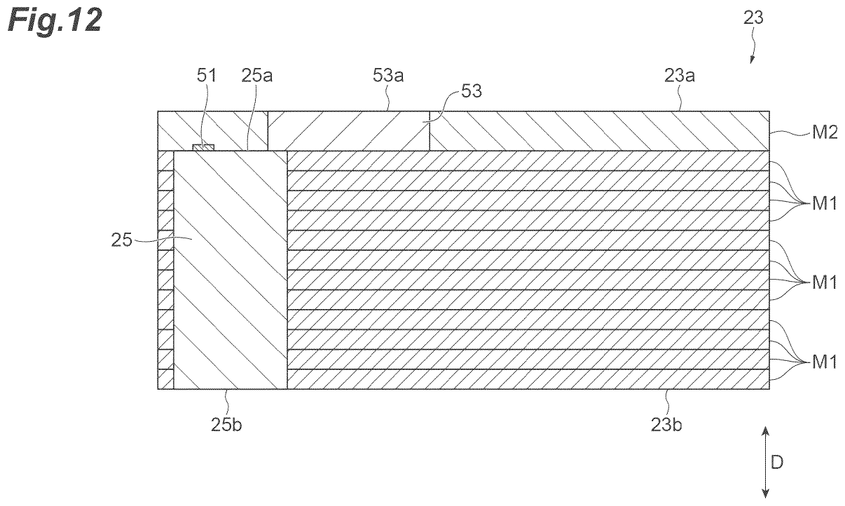

Next, a configuration of a modification of the rotating electrical machine MT will be described with reference to FIG. 12. FIG. 12 is a diagram illustrating a cross-sectional configuration of a rotor core. In the present modification, the configuration of the rotor core 23 and the arrangement of the coils 53 are different from that of the above-described embodiment. Hereinafter, differences between the above-described embodiment and the present modification will be mainly described.

In the present modification, as illustrated in FIG. 12, the rotor core 23 includes the plurality of steel sheets M1 and a plate M2. The plate M2 has electric conductivity. The plate M2 includes, for example, stainless steel or aluminum. The plate M2 is disposed on the steel sheet M1 disposed on the outermost side in the rotation axis direction D and closer to the coil 61 among the plurality of steel sheets M1 in the state where the rotor 20 is at the predetermined rotation angle. In the present modification, the plate M2 includes the end surface 23a as a surface thereof. In the present modification, the temperature sensitive element 51 and the coil 53 are embedded in the plate M2. The end 53a of the coil 53 is exposed to the end surface 23a included in the plate M2. Also in the present modification in which the end surface 23a is included in the plate M2, the end surface 23a is on the same plane as the end 53a of the coil 53. Also in the present modification, for example, the portion closer to the end 53a in the side portion of the coil 53 may be exposed from the rotor core 23. The end surface 23a included in the plate M2 may not be on the same plane as the end 53a.

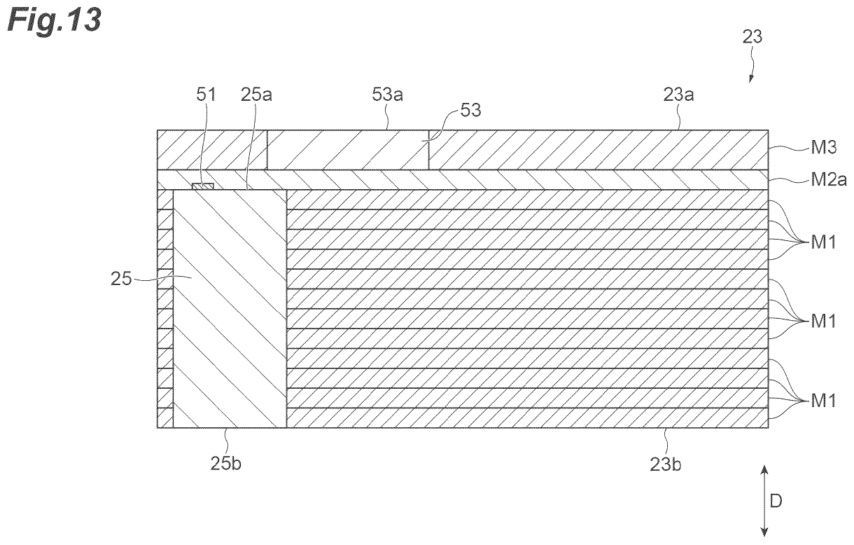

Next, a configuration of another modification of the rotating electrical machine MT will be described with reference to FIG. 13. FIG. 13 is a diagram illustrating a cross-sectional configuration of a rotor core. Also in the present modification, the configuration of the rotor core 23 and the arrangement of the coils 53 are different from that of the above-described embodiment. Hereinafter, differences between the above-described embodiment and the present modification will be mainly described.

In the present modification, as illustrated in FIG. 13, the rotor core 23 includes the plurality of steel sheets M1, a plate M2a, and a plate M3 different from the plate M2a. The plate M2a does not have electric conductivity, and the plate M3 has electric conductivity. The plate M2a is disposed on the steel sheet M1 disposed on the outermost side in the rotation axis direction D and closer to the coil 61 among the plurality of steel sheets M1. The plate M3 is disposed on the plate M2a. Therefore, in the present modification, the plate M3 is also disposed on the steel sheet M1 disposed on the outermost side in the rotation axis direction D and closer to the coil 61 among the plurality of steel sheets M1. In the present modification, the plate M3 includes the end surface 23a as a surface thereof. In the present modification, the temperature sensitive element 51 is embedded in the plate M2a, and the coil 53 is embedded in the plate M3.

The end 53a of the coil 53 is exposed to the end surface 23a included in the plate M3. Also in the present modification in which the end surface 23a is included in the plate M3, the end surface 23a is on the same plane as the end 53a of the coil 53. Also in the present modification, for example, the portion closer to the end 53a in the side portion of the coil 53 may be exposed from the rotor core 23. The end surface 23a included in the plate M3 may not be on the same plane as the end 53a.

Although the embodiment of the present disclosure has been described in the foregoing, the present disclosure is not necessarily limited to the above-described embodiment, and various modifications can be made without departing from the gist thereof.

In the magnet temperature information output device 1, the output section 80 may include the electric resistance element 70. In the configuration in which the output section 80 includes the electric resistance element 70, the electric resistance element 70 may be an internal electric resistance of the output section 80. In a configuration in which the electric resistance element 70 is the internal electric resistance of the output section 80, the frequency of the voltage applied to the coil 61 may be a secondary resonance frequency among the predetermined resonance frequencies for exciting the coil 53. In a configuration in which the electric resistance element 70 is the internal electric resistance of the output section 80 and the frequency of the voltage applied to the coil 61 is the secondary resonance frequency among the predetermined resonance frequencies, the magnet temperature information output device 1 accurately outputs the temperature information regarding the temperature of the permanent magnet 25. In a configuration in which the electric resistance element 70 is not the internal resistance of the output section 80, the frequency of the voltage applied to the coil 61 may be a primary resonance frequency among the predetermined resonance frequencies.

In the magnet temperature information output device 1, the electric resistance element 70 may not have the electric resistance of greater than or equal to Zₒ^{0.50}×Z₁₅₀^{0.28} and less than or equal to Zₒ^{0.50}×Z₁₅₀^{0.71}.

The magnet temperature information output device 1 in which the electric resistance element 70 has the electric resistance of greater than or equal to Zₒ^{0.50}×Z₁₅₀^{0.28} and less than or equal to Zₒ^{0.50}×Z₁₅₀^{0.71} accurately outputs the temperature information regarding the temperature of the permanent magnet as described above.

The magnet temperature information output device 1 may not include the capacitor 63.

As described above, the magnet temperature information output device 1 including the capacitor 63 accurately detects the change in the electric resistance of the temperature sensitive element 51.

In the rotating electrical machine MT, the coil 53 and the coil 61 may not be disposed to oppose each other in the rotation axis direction D in the state where the rotor 20 is at the predetermined rotation angle position.

In the rotating electrical machine MT in which the coil 53 and the coil 61 are disposed to oppose each other in the rotation axis direction D in the state where the rotor 20 is at the predetermined rotation angle position, as described above, the magnetic flux generated in the stator coil 11 hardly affects the coil 53 and the coil 61.

In the rotating electrical machine MT, the temperature sensitive element 51 may not be disposed to be in contact with the surface 25a of the permanent magnet 25. The entire permanent magnet 25 and the part of the coil 53 may not be disposed in the rotor core 23.

The control circuit 41 may not function as the magnet temperature acquisition device. The control circuit 41 may control the driving state of the rotating electrical machine MT based on the electric signal responding to the magnitude of the voltage drop occurring in the electric resistance element 70 input from the output section 80. In this case, the control circuit 41 may control the driving state of the rotating electrical machine MT as follows. In a case where the control circuit 41 determines that the electric signal input from the output section 80 indicates that the temperature of the permanent magnet 25 has increased to the predetermined first threshold value, the control circuit 41 performs a control to reduce the driving frequency to limit the rotational speed of the rotating electrical machine MT. In a case where the control circuit 41 determines that the electric signal input from the output section 80 indicates that the temperature of the permanent magnet 25 has decreased to the predetermined second threshold value smaller than the first threshold value, the control circuit 41 performs a control to increase the driving frequency to release the limitation on the rotational speed of the rotating electrical machine MT.

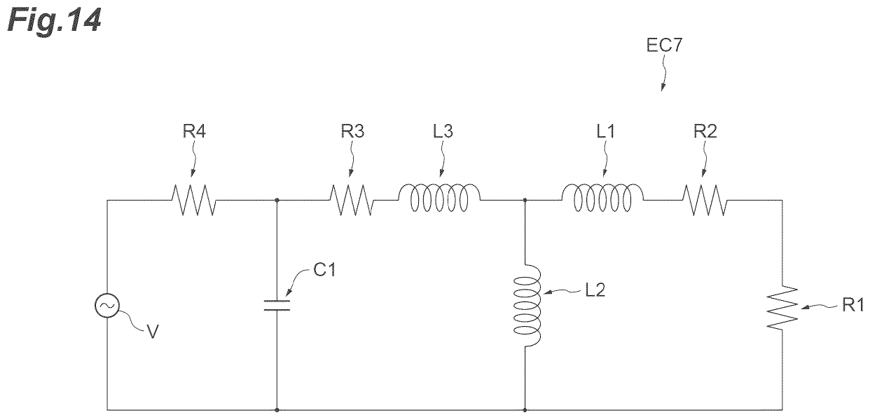

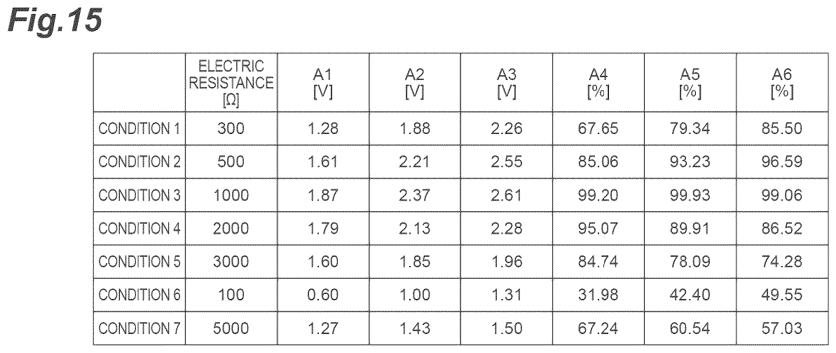

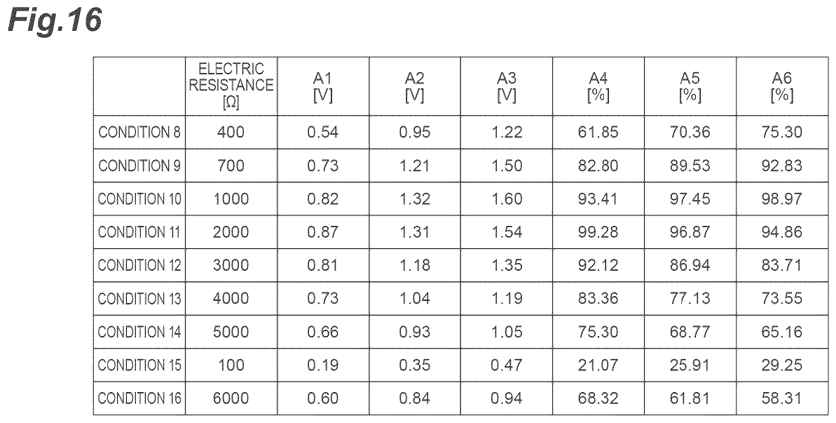

Next, experiments conducted by the present inventors to explain that the change in the temperature of the permanent magnet 25 is accurately detected in the first range of the electric resistance of the electric resistance element 70 will be described with reference to FIGS. 14, 15, and 16. Experiments conducted by the present inventors to explain that the change in the temperature of the permanent magnet 25 is detected more accurately in the second range of the electric resistance of the electric resistance element 70 will also be described. FIG. 14 is a circuit diagram illustrating an equivalent circuit used when obtained the relationship between the electric resistance of the electric resistance element and the accuracy of temperature information. FIGS. 15 and 16 are tables illustrating the relationship between the electric resistance of the electric resistance element and the accuracy of temperature information. The present inventors conducted experiments under the following conditions 1 to 16 using an equivalent circuit EC7 illustrated in FIG. 14 and the equivalent circuit EC2 illustrated in FIG. 4.

The equivalent circuit EC7 is a circuit equivalently representing a circuit including the temperature sensitive element 51, the coil 53, the coil 61, the capacitor 63, the AC power supply PS, and the electric resistance element 70 in the magnet temperature information output device 1. Therefore, the equivalent circuit EC7 includes elements corresponding to the temperature sensitive element 51, the coil 53, the coil 61, the capacitor 63, the AC power supply PS, and the electric resistance element 70.

The equivalent circuit EC7 includes the element R1, the elements L1 and R2, the element L2, the elements L3 and R3, the element C1, a power supply V, and an element R4. The power supply V corresponds to the AC power supply PS. The element R4 corresponds to the electric resistance element 70. In the equivalent circuit EC7, the element R4 includes an element corresponding to the electric resistance of the electric resistance element 70.

In the equivalent circuit EC7, the element L3 is electrically connected to the power supply V. A voltage is applied from the power supply V to the element L3. In the equivalent circuit EC7, a voltage corresponding to the AC voltage applied from the AC power supply PS to the coil 61 is applied from the power supply V to the element L3. The element R4 is inserted between the element R3 and the power supply V. In the equivalent circuit EC7, the portion including the element R1 and the elements R2 and L1 corresponds to the element 50. The portion including the elements L3 and R3 and the element C1 corresponds to the element 60.

### (Condition 1)

In condition 1, the power supply V was set as a power supply that applies an AC voltage having a frequency of 85 kHz and a voltage of 4.5 V to the element L3. The element R2 and the element R3 were set as elements having an electric resistance of 2.4 Ω. The element L1 and the element L3 were set as elements having an inductance of 160 μH. The element L2 was set as an element having a coupling constant of 0.7. The element C1 was set as an element having a capacitance of 22 nF. The element R4 was set as an element having an electric resistance of 300 Ω. The combined impedance Z₁₅₀ was set to 294 Ω. The combined impedance Zₒ was set to 2980 Ω.

In condition 1, the first range of the electric resistance of the electric resistance element 70, which is set using the combined impedance Z₁₅₀ and the combined impedance Zₒ, was greater than or equal to 268.07 Ω and less than or equal to 3087.70 Ω. Furthermore, under condition 1, the second range of electric resistance of the electric resistance element 70 was greater than or equal to 473.24 Ω and less than or equal to 1959.60 Ω. That is, under condition 1, the electric resistance of the element R4 was within the first range of the electric resistance and outside the second range of the electric resistance.

In condition 1, a magnitude of the voltage drop occurring in the element R4 when the temperature of the element R1 is T° C. was calculated. In condition 1, a magnitude of the voltage drop occurring in the element R4 when the temperature of the element R1 is −40° C. was calculated. The temperature T of the element R1 was set in a range of higher than or equal to 120° C. and lower than or equal to 170° C.

Hereinafter, the magnitude of the voltage drop occurring in the element R4 when the temperature of the element R1 is higher than or equal to 120° C. and lower than or equal to 170° C. is sometimes referred to as V(T). A magnitude of the voltage drop occurring in the element R4 when the temperature of the element R4 is −40° C. is sometimes referred to as V(−40). For example, a magnitude of the voltage drop occurring in the element R4 when the temperature of the element R1 is 120° C. is referred to as V(120).

In condition 1, indices A1, A2, and A3 were calculated as indices indicating the accuracy of the temperature information. In condition 1, indices A4, A5, and A6 were calculated as indices indicating the relative accuracy of the temperature information. The index A1 is represented by a relational expression A1=V(120)−V(−40). The index A2 is represented by a relational expression A2=V(150)−V(−40). The index A3 is represented by a relational expression A3=V(170)−V(−40). The index A4 is expressed by a relational expression A4={V(120)−V(−40)}/Vmax. The index A5 is expressed by a relational expression A5={V(150)−V(−40)}/Vmax. The index A6 is expressed by a relational expression A6={V(170)−V(−40)}/Vmax. Here, Vmax represents a maximum value of V(T) within the range of higher than or equal to 120° C. and lower than or equal to 170° C.

### (Condition 2)

In condition 2, the indices A1, A2, and A3 and the indices A4, A5, and A6 were calculated similarly to condition 1 except that the element R4 was set as an element having an electric resistance of 500 Ω. In condition 2, the electric resistance of the element R4 was within the first range of the electric resistance and within the second range of the electric resistance.

### (Condition 3)

In condition 3, the indices A1, A2, and A3 and the indices A4, A5, and A6 were calculated similarly to condition 1 except that the element R4 was set as an element having an electric resistance of 1000 Ω. In condition 3, the electric resistance of the element R4 was within the first range of the electric resistance and within the second range of the electric resistance.

### (Condition 4)

In condition 4, the indices A1, A2, and A3 and the indices A4, A5, and A6 were calculated similarly to condition 1 except that the element R4 was set as an element having an electric resistance of 2000 Ω. In condition 4, the electric resistance of the element R4 was within the first range of the electric resistance and within the second range of the electric resistance.

### (Condition 5)

In condition 5, the indices A1, A2, and A3 and the indices A4, A5, and A6 were calculated similarly to condition 1 except that the element R4 was set as an element having an electric resistance of 3000 Ω. In condition 5, the electric resistance of the element R4 was within the first range of the electric resistance and outside the second range of the electric resistance.

### (Condition 6)

In condition 6, the indices A1, A2, and A3 and the indices A4, A5, and A6 were calculated similarly to condition 1 except that the element R4 was set as an element having an electric resistance of 100 Ω. In condition 6, the electric resistance of the element R4 was outside the first range of the electric resistance and outside the second range of the electric resistance.

### (Condition 7)

In condition 7, the indices A1, A2, and A3 and the indices A4, A5, and A6 were calculated similarly to condition 1 except that the element R4 was set as an element having an electric resistance of 5000 Ω. In condition 7, the electric resistance of the element R4 was outside the first range of the electric resistance and outside the second range of the electric resistance.

### (Condition 8)

In condition 8, the power supply V was set as a power supply that applies an AC voltage having a frequency of 420 kHz and a voltage of 5.0 V to the element L3. The element R2 and the element R3 were set as elements having an electric resistance of 2.4 Ω. The element L1 and the element L3 were set as elements having an inductance of 30 μH. The element L2 was set as an element having a coupling constant of 0.5. The element C1 was set as an element having a capacitance of 4.7 nF. The element R4 was set as an element having an electric resistance of 400 Ω. The combined impedance Z₁₅₀ was set to 148.8 Ω. The combined impedance Zₒ was set to 2330 Ω.

In condition 8, the first range of the electric resistance of the electric resistance element 70, which is set using the combined impedance Z₁₅₀ and the combined impedance Zₒ, was greater than or equal to 317.50 Ω and less than or equal to 5728.95 Ω. Furthermore, under condition 8, the second range of electric resistance of the electric resistance element 70 was greater than or equal to 622.18 Ω and less than or equal to 3344.57 Ω. That is, under condition 8, the electric resistance of the element R4 was within the first range of the electric resistance and outside the second range of the electric resistance.

In condition 8, similarly to conditions 1 to 7, the indices A1, A2, and A3 were calculated as indices indicating the accuracy of the temperature information. In condition 8, the indices A4, A5, and A6 were calculated as the indices indicating the relative accuracy of the temperature information.

### (Condition 9)

In condition 9, the indices A1, A2, and A3 and the indices A4, A5, and A6 were calculated similarly to condition 8 except that the element R4 was set as an element having an electric resistance of 700 Ω. In condition 9, the electric resistance of the element R4 was within the first range of the electric resistance and within the second range of the electric resistance.

### (Condition 10)

In condition 10, the indices A1, A2, and A3 and the indices A4, A5, and A6 were calculated similarly to condition 8 except that the element R4 was set as an element having an electric resistance of 1000 Ω. In condition 10, the electric resistance of the element R4 was within the first range of the electric resistance and within the second range of the electric resistance.

### (Condition 11)

In condition 11, the indices A1, A2, and A3 and the indices A4, A5, and A6 were calculated similarly to condition 8 except that the element R4 was set as an element having an electric resistance of 2000 Ω. In condition 11, the electric resistance of the element R4 was within the first range of the electric resistance and within the second range of the electric resistance.

### (Condition 12)

In condition 12, the indices A1, A2, and A3 and the indices A4, A5, and A6 were calculated similarly to condition 8 except that the element R4 was set as an element having an electric resistance of 3000 Ω. In condition 12, the electric resistance of the element R4 was within the first range of the electric resistance and within the second range of the electric resistance.

### (Condition 13)

In condition 13, the indices A1, A2, and A3 and the indices A4, A5, and A6 were calculated similarly to condition 8 except that the element R4 was set as an element having an electric resistance of 4000 Ω. In condition 13, the electric resistance of the element R4 was within the first range of the electric resistance and within the second range of the electric resistance.

### (Condition 14)

In condition 14, the indices A1, A2, and A3 and the indices A4, A5, and A6 were calculated similarly to condition 8 except that the element R4 was set as an element having an electric resistance of 5000 Ω. In condition 14, the electric resistance of the element R4 was within the first range of the electric resistance and outside the second range of the electric resistance.

### (Condition 15)

In condition 15, the indices A1, A2, and A3 and the indices A4, A5, and A6 were calculated similarly to condition 8 except that the element R4 was set as an element having an electric resistance of 100 Ω. In condition 15, the electric resistance of the element R4 was outside the first range of the electric resistance and outside the second range of the electric resistance.

### (Condition 16)

In condition 16, the indices A1, A2, and A3 and the indices A4, A5, and A6 were calculated similarly to condition 8 except that the element R4 was set as an element having an electric resistance of 6000 Ω. In condition 16, the electric resistance of the element R4 was outside the first range of the electric resistance and outside the second range of the electric resistance.

FIG. 15 illustrates calculation results of conditions 1 to 7. FIG. 15 illustrates the indices A1, A2, and A3 and the indices A4, A5, and A6 together with the electric resistance of the element R4 under conditions 1 to 7. FIG. 16 illustrates calculation results of conditions 8 to 16. FIG. 16 illustrates the indices A1, A2, and A3 and the indices A4, A5, and A6 together with the electric resistance of the element R4 under conditions 8 to 16.

As illustrated in FIGS. 15 and 16, it can be seen that the indices A4, A5, and A6 are greater than or equal to 60% under condition 1 to condition 5 and condition 8 to condition 14 in which the electric resistance of the element R4 is within the first range of the electric resistance. Therefore, it is understood that the change in the temperature of the permanent magnet 25 is accurately detected in the first range of the electric resistance. Furthermore, it can be seen that the indices A4, A5, and A6 are greater than or equal to 80% under condition 2 to condition 4 and condition 9 to condition 12 in which the electric resistance of the element R4 is within the second range of the electric resistance. Therefore, it is understood that the change in the temperature of the permanent magnet 25 is more accurately detected in the second range of the electric resistance.

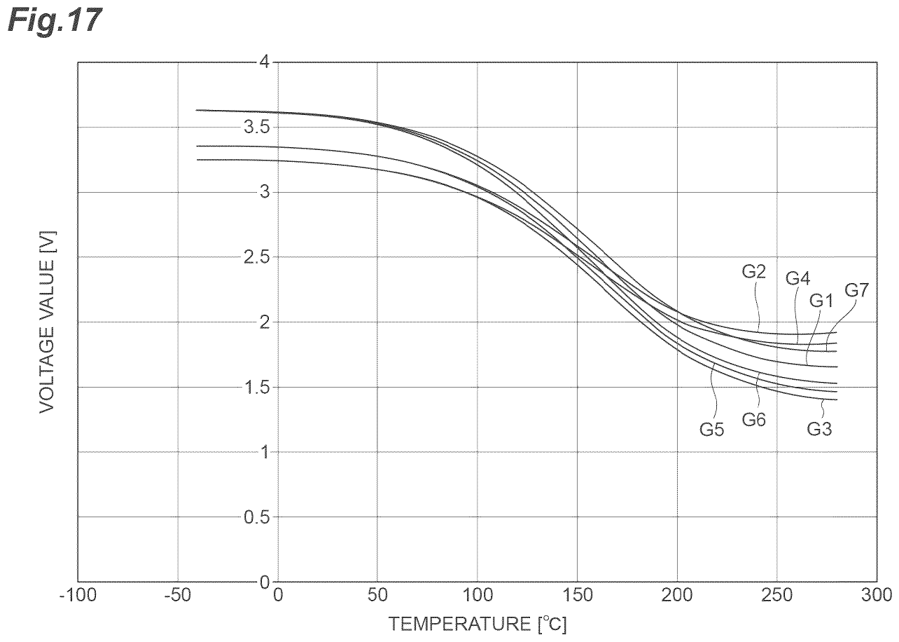

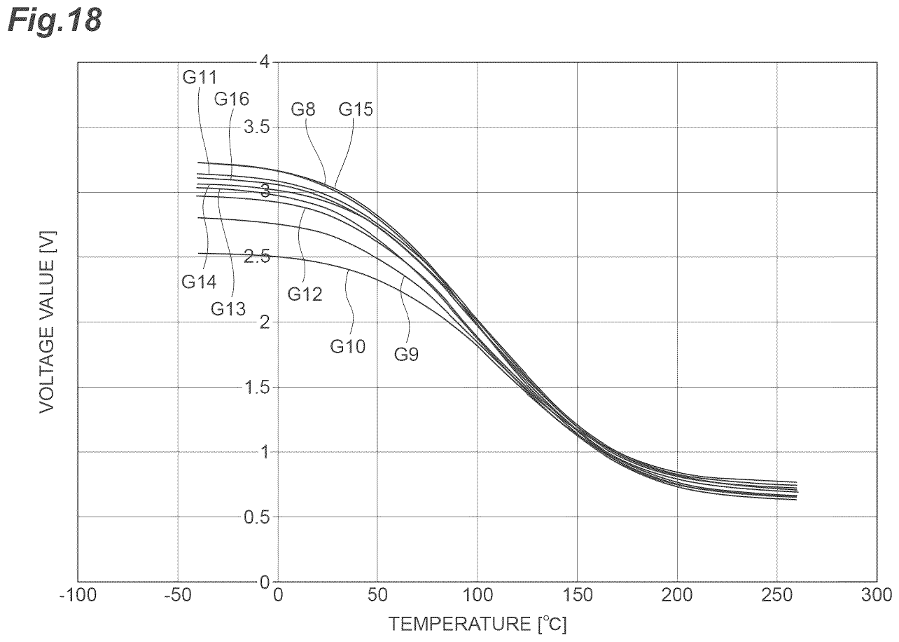

Next, with reference to FIGS. 17 and 18, an experiment conducted by the present inventors to describe that the magnet temperature information output device 1 accurately outputs the temperature information regarding the temperature of the permanent magnet 25 will be described. In the magnet temperature information output device 1 in the experiment, the element 60 includes the capacitor 63, and the element 50 includes the capacitor 55. FIGS. 17 and 18 are diagrams illustrating a relationship between a voltage drop occurring in the electric resistance element and a temperature.

The present inventors conducted experiments under the following conditions 17 to 23 using an equivalent circuit obtained by adding the element R4 and the power supply V to the equivalent circuit EC1 illustrated in FIG. 3. In the equivalent circuit obtained by adding the element R4 and the power supply V to the equivalent circuit EC1, the power supply V is electrically connected to the element L3, and the element R4 is inserted between the element R3 and the power supply V. The voltage responding to the AC voltage applied from the AC power supply PS to the coil 61 is applied from the power supply V to the element L3. For example, a voltage responding to a difference between the corresponding voltage and a voltage drop occurring in the element R4 is applied to the element L3. As a result, the present inventors have confirmed the relationship between the voltage drop and the temperature in the configuration in which the element 60 includes the capacitor 63 and the element 50 does not include the capacitor 55.

The present inventors conducted experiments under the following conditions 24 to 32 using an equivalent circuit obtained by adding the element R4 and the power supply V to the equivalent circuit EC3 illustrated in FIG. 7. In the equivalent circuit obtained by adding the element R4 and the power supply V to the equivalent circuit EC3, the power supply V is electrically connected to the element L3, and the element R4 is inserted between the element R3 and the power supply V. The voltage responding to the AC voltage applied from the AC power supply PS to the coil 61 is applied from the power supply V to the element L3. For example, the voltage responding to the difference between the corresponding voltage and the voltage drop occurring in the element R4 is applied to the element L3. As a result, the present inventors have confirmed the relationship between the voltage drop and the temperature in the configuration in which the element 60 includes the capacitor 63 and the element 50 includes the capacitor 55.

### (Condition 17)

In condition 17, the power supply V was set as a power supply that applies, to the element L3, an AC voltage whose frequency is the reference resonance frequency and whose voltage is a reference voltage. The element R2 and the element R3 were set as elements having a first reference electric resistance. The element L1 and the element L3 were set as elements having a reference inductance. The element L2 was set as an element having a reference coupling constant. The element C1 was set as an element having a first reference capacitance. The element R4 was set as an element having a second reference electric resistance. An AC voltage was applied from the power supply V to the element L3 via the element R4. A frequency of the AC voltage was a reference frequency. The voltage of the AC voltage was a reference voltage. That is, a voltage responding to a difference between the reference voltage and the voltage drop occurring in the element R4 was applied to the element L3.

The reference voltage, the first reference electric resistance, the reference inductance, the first reference capacitance component, and the second reference electric resistance were set based on, for example, standards of the coil 53, the coil 61, the capacitor 63, and the electric resistance element 70 adopted when actually using the magnet temperature information output device 1. The reference coupling constant was a coupling constant between the coil 53 and the coil 61 in a configuration in which the opposing distance between the coil 53 and the coil 61 was 3.0 mm. In condition 17, the relationship between the electric signal and the temperature was obtained through acquiring the electric signal responding to the magnitude of the voltage drop occurring in the element R4 while changing the temperature of the element R1. In condition 17, an electric signal indicating the voltage across the element C1 was acquired as the electric signal responding to the magnitude of the voltage drop occurring in the element R4.

### (Condition 18)

In condition 18, the relationship between the electric signal responding to the magnitude of the voltage drop occurring in the element R4 and the temperature was obtained similarly to condition 17 except that the element L1 and the element L3 were set as elements having inductances in which the reference inductance was increased by 5%.

### (Condition 19)

In condition 19, the relationship between the electric signal responding to the magnitude of the voltage drop occurring in the element R4 and the temperature was obtained similarly to condition 17 except that the element L1 and the element L3 were set as elements having inductances in which the reference inductance was decreased by 5%.

### (Condition 20)

In condition 20, the relationship between the electric signal responding to the magnitude of the voltage drop occurring in the element R4 and the temperature was obtained similarly to condition 17 except that the element C1 was set as an element having a capacitance in which the first reference capacitance component was increased by 5%.

### (Condition 21)

In condition 21, the relationship between the electric signal responding to the magnitude of the voltage drop occurring in the element R4 and the temperature was obtained similarly to condition 17 except that the element C1 was set as an element having a capacitance in which the first reference capacitance component was decreased by 5%.

### (Condition 22)

In condition 22, the relationship between the electric signal responding to the magnitude of the voltage drop occurring in the element R4 and the temperature was obtained similarly to condition 17 except that the element L2 was set as an element having a coupling constant in which the reference coupling constant was increased by 5%.

### (Condition 23)

In condition 23, the relationship between the electric signal responding to the magnitude of the voltage drop occurring in the element R4 and the temperature was obtained similarly to condition 17 except that the element L2 was set as an element having a coupling constant in which the reference coupling constant was decreased by 5%.

### (Condition 24)

In condition 24, the power supply V was set as a power supply that applies, to the element L3, an AC voltage whose frequency is the reference resonance frequency and whose voltage is the reference voltage. The element R2 and the element R3 were set as elements having the first reference electric resistance. The element L1 and the element L3 were set as elements having the reference inductance. The element L2 was set as an element having the reference coupling constant. The element C1 was set as an element having the first reference capacitance. The element C2 was set as an element having a second reference capacitance. The element R4 was set as an element having the second reference electric resistance. The second reference capacitance was set based on, for example, a standard of the capacitor 55 adopted when actually using the magnet temperature information output device 1. The AC voltage was applied from the power supply V to the element L3 via the element R4. The frequency of the AC voltage was the reference frequency. The voltage of the AC voltage was the reference voltage. That is, the voltage responding to the difference between the reference voltage and the voltage drop occurring in the element R4 was applied to the element L3. In condition 24, the electric signal responding to the magnitude of the voltage drop occurring in the element R4 was acquired, and the relationship between the electric signal and the temperature was obtained. In condition 24, the signal indicating the voltage across the element C1 was acquired as the electric signal responding to the magnitude of the voltage drop occurring in the element R4.

### (Condition 25)

In condition 25, the relationship between the electric signal responding to the magnitude of the voltage drop occurring in the element R4 and the temperature was obtained similarly to condition 24 except that the element L1 and the element L3 were set as elements having inductances in which the reference inductance was increased by 5%.

### (Condition 26)

In condition 26, the relationship between the electric signal responding to the magnitude of the voltage drop occurring in the element R4 and the temperature was obtained similarly to condition 24 except that the element L1 and the element L3 were set as elements having inductances in which the reference inductance was decreased by 5%.

### (Condition 27)

In condition 27, the relationship between the electric signal responding to the magnitude of the voltage drop occurring in the element R4 and the temperature was obtained similarly to condition 24 except that the element C1 was set as an element having a capacitance in which the first reference capacitance was increased by 5%.

### (Condition 28)

In condition 28, the relationship between the electric signal responding to the magnitude of the voltage drop occurring in the element R4 and the temperature was obtained similarly to condition 24 except that the element C1 was set as an element having a capacitance in which the first reference capacitance was decreased by 5%.

### (Condition 29)

In condition 29, the relationship between the electric signal responding to the magnitude of the voltage drop occurring in the element R4 and the temperature was obtained similarly to condition 24 except that the element C2 was set as an element having a capacitance in which the second reference capacitance component was increased by 5%.

### (Condition 30)

In condition 30, the relationship between the electric signal responding to the magnitude of the voltage drop occurring in the element R4 and the temperature was obtained similarly to condition 24 except that the element C2 was set as an element having a capacitance in which the second reference capacitance was decreased by 5%.

### (Condition 31)

In condition 31, the relationship between the electric signal responding to the magnitude of the voltage drop occurring in the element R4 and the temperature was obtained similarly to condition 24 except that the element L2 was set as an element having a coupling constant in which the reference coupling constant was increased by 5%.

### (Condition 32)

In condition 32, the relationship between the electric signal responding to the magnitude of the voltage drop occurring in the element R4 and the temperature was obtained similarly to condition 24 except that the element L2 was set as an element having a coupling constant in which the reference coupling constant was decreased by 5%.

FIG. 17 illustrates results of conditions 17 to 23. FIG. 18 illustrates results of conditions 24 to 32. In the graphs illustrated in FIGS. 17 and 18, the horizontal axis represents the temperature [° C.], and the vertical axis represents the voltage value [V] based on the electric signal responding to the magnitude of the voltage drop.

In FIG. 17, a relationship G1 indicates the relationship between the voltage drop and the temperature obtained under condition 17. A relationship G2 indicates the relationship between the voltage drop and the temperature obtained under condition 18. A relationship G3 indicates the relationship between the voltage drop and the temperature obtained under condition 19. A relationship G4 indicates the relationship between the voltage drop and the temperature obtained under condition 20. A relationship G5 indicates the relationship between the voltage drop and the temperature obtained under condition 21. A relationship G6 indicates the relationship between the voltage drop and the temperature obtained under condition 22. A relationship G7 indicates the relationship between the voltage drop and the temperature obtained under condition 23.

In FIG. 18, a relationship G8 indicates the relationship between

the voltage drop and the temperature obtained under condition 24. A relationship G9 indicates the relationship between the voltage drop and the temperature obtained under condition 25. A relationship G10 indicates the relationship between the voltage drop and the temperature obtained under condition 26. A relationship G11 indicates the relationship between the voltage drop and the temperature obtained under condition 27. A relationship G12 indicates the relationship between the voltage drop and the temperature obtained under condition 28. A relationship G13 indicates the relationship between the voltage drop and the temperature obtained under condition 29. A relationship G14 indicates the relationship between the voltage drop and the temperature obtained under condition 30. A relationship G15 indicates the relationship between the voltage drop and the temperature obtained under condition 31. A relationship G16 indicates the relationship between the voltage drop and the temperature obtained under condition 32.

In the relationships G1 to G16, the fact that the change in the voltage value accompanying the increase in the temperature is large indicates that the accuracy of detecting the change in the electric resistance of the temperature sensitive element 51 is improved. For example, in the relationship G1, a voltage value at 25° C. is about 3.6 V, and a voltage value at 150° C. is about 2.6 V. That is, in the relationship G1, a difference between the voltage value at 25° C. and the voltage value at 150° C. is about 1.0 V.

On the other hand, in the relationship G8, the voltage value at 25° C. is about 3.1 V, and the voltage value at 150° C. is about 1.1 V. That is, in the relationship G8, the difference between the voltage value at 25° C. and the voltage value at 150° C. is about 2.0 V. Therefore, in the relationship G8, it can be seen that the change in the voltage value accompanying the increase in temperature is large as compared with that in the relationship G1.

As illustrated in FIGS. 17 and 18, it can be seen that in the relationships G9 to G16 as well, the change in the voltage value accompanying the increase in the temperature is large as compared with the relationships G2 to G7. Thus, it can be seen that, in the configuration in which the element 60 includes the capacitor 63 and the element 50 includes the capacitor 55, the change in the voltage value accompanying the increase in temperature is large as compared with the configuration in which the element 60 includes the capacitor 63 and the element 50 does not include the capacitor 55.

As illustrated in FIGS. 17 and 18, it can be seen that, in a range of higher than or equal to 100° C., a deviation of each of the relationships G9 to G16 with respect to the relationship G8 is smaller than a deviation of each of the relationships G2 to G7 with respect to the relationship G1. Thus, it can be seen that, even if the inductance of the coils 53 and 61, the capacitance of the capacitors 55 and 63, and the coupling constant between the coil 53 and the coil 61 are deviated from the design value, in the configuration in which the element 60 includes the capacitor 63 and the element 50 includes the capacitor 55, the deviation in the output electric signal amplitude is reduced. Therefore, in the configuration in which the element 60 includes the capacitor 63 and the element 50 includes the capacitor 55, the magnet temperature information output device 1 accurately outputs the temperature information regarding the temperature of the permanent magnet 25.

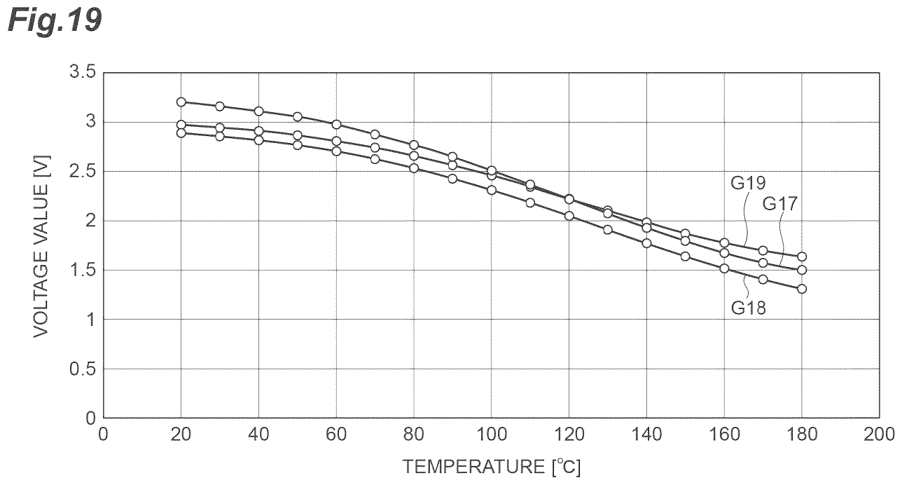

Next, with reference to FIGS. 19, 20, 21, 22, and 23, another experiment conducted by the present inventors to describe that the magnet temperature information output device 1 accurately outputs the temperature information regarding the temperature of the permanent magnet 25 will be described. In another experiment described above, the coil 61 was applied with a voltage having a frequency smaller than the predetermined resonance frequency for exciting the coil 53, and the difference between the frequency and the predetermined resonance frequency was greater than or equal to 5 kHz and less than or equal to 30 kHz. FIGS. 19, 20, 21, 22, and 23 are diagrams illustrating a relationship between a voltage drop occurring in the electric resistance element and a temperature. The present inventors conducted experiments under the following conditions 34 to 48 using the equivalent circuit obtained by adding the element R4 and the power supply V to the equivalent circuit EC2 illustrated in FIG. 7. As a result, the present inventors have confirmed the relationship between the voltage drop and the temperature when the frequency of the voltage applied to the coil 61 is smaller than the predetermined resonance frequency and the difference between the frequency and the predetermined resonance frequency is greater than or equal to 5 kHz and less than or equal to 30 kHz.

### (Condition 34)

In condition 34, the power supply V was set as a power supply that applies, to the element L3, the AC voltage whose frequency is the reference resonance frequency and whose voltage is the reference voltage. As described above, the reference resonance frequency is an example of the predetermined resonance frequency for exciting the coil 53. Therefore, in the condition 34, the predetermined resonance frequency for exciting the coil 53 was set as the frequency of the voltage applied to the element L3. The element R2 and the element R3 were set as elements having the first reference electric resistance. The element L1 and the element L3 were set as elements having the reference inductance. The element L2 was set as an element having the reference coupling constant. The element C1 was set as an element having the first reference capacitance component. The element C2 was set as an element having the second reference capacitance component. The element R4 was set as an element having the second reference electric resistance. The AC voltage was applied from the power supply V to the element L3 via the element R4. The frequency of the AC voltage was the reference frequency. The voltage of the AC voltage was the reference voltage. That is, a voltage responding to the difference between the reference voltage and the voltage drop occurring in the element R4 was applied to the element L3. In condition 34, the relationship between the electric signal and the temperature was obtained through acquiring the electric signal responding to the magnitude of the voltage drop occurring in the element R4 while changing the temperature of the element R1. In condition 34, the signal indicating the voltage across the element C1 was acquired as the electric signal responding to the magnitude of the voltage drop occurring in the element R4.

### (Condition 35)

In condition 35, the relationship between the electric signal responding to the magnitude of the voltage drop occurring in the element R4 and the temperature was obtained similarly to condition 34 except that the element L2 was set as an element having a first coupling constant. The first coupling constant was a coupling constant between the coil 53 and the coil 61 in a configuration in which the opposing distance between the coil 53 and the coil 61 was 2.5 mm.

### (Condition 36)

In condition 36, the relationship between the electric signal responding to the magnitude of the voltage drop occurring in the element R4 and the temperature was obtained similarly to condition 34 except that the element L2 was set as an element having a second coupling constant. The second coupling constant was a coupling constant between the coil 53 and the coil 61 in a configuration in which the opposing distance between the coil 53 and the coil 61 was 3.5 mm.

(Condition 37)

In condition 37, the relationship between the electric signal responding to the magnitude of the voltage drop occurring in the element R4 and the temperature was obtained similarly to the condition 34 except that the power supply V was set as the power supply that applies the AC voltage having a frequency smaller than the reference resonance frequency by 5 kHz to the element L3. That is, in condition 37, the frequency smaller by 5 kHz than the predetermined resonance frequency for exciting the coil 53 was set as the frequency of the voltage applied to the element L3.

### (Condition 38)

In condition 38, the relationship between the electric signal responding to the magnitude of the voltage drop occurring in the element R4 and the temperature was obtained similarly to condition 37 except that the element L2 was set as an element having the first coupling constant.

### (Condition 39)

In condition 39, the relationship between the electric signal responding to the magnitude of the voltage drop occurring in the element R4 and the temperature was obtained similarly to condition 37 except that the element L2 was set as an element having the second coupling constant.

### (Condition 40)

In condition 40, the relationship between the electric signal responding to the magnitude of the voltage drop occurring in the element R4 and the temperature was obtained similarly to the condition 34 except that the power supply V was set as the power supply that applies the AC voltage having a frequency smaller than the reference resonance frequency by 10 kHz to the element L3. That is, in condition 40, the frequency smaller by 10 kHz than the predetermined resonance frequency for exciting the coil 53 was set as the frequency of the voltage applied to the element L3.

### (Condition 41)

In condition 41, the relationship between the electric signal responding to the magnitude of the voltage drop occurring in the element R4 and the temperature was obtained similarly to condition 40 except that the element L2 was set as an element having the first coupling constant.

### (Condition 42)

In condition 42, the relationship between the electric signal responding to the magnitude of the voltage drop occurring in the element R4 and the temperature was obtained similarly to condition 40 except that the element L2 was set as an element having the second coupling constant.

### (Condition 43)

In condition 43, the relationship between the electric signal responding to the magnitude of the voltage drop occurring in the element R4 and the temperature was obtained similarly to the condition 34 except that the power supply V was set as the power supply that applies the AC voltage having a frequency smaller than the reference resonance frequency by 20 kHz to the element L3. That is, in condition 43, the frequency smaller by 20 kHz than the predetermined resonance frequency for exciting the coil 53 was set as the frequency of the voltage applied to the element L3.

### (Condition 44)

In condition 44, the relationship between the electric signal responding to the magnitude of the voltage drop occurring in the element R4 and the temperature was obtained similarly to condition 43 except that the element L2 was set as an element having the first coupling constant.

### (Condition 45)

In condition 45, the relationship between the electric signal responding to the magnitude of the voltage drop occurring in the element R4 and the temperature was obtained similarly to condition 43 except that the element L2 was set as an element having the second coupling constant.

### (Condition 46)

In condition 46, the relationship between the electric signal responding to the magnitude of the voltage drop occurring in the element R4 and the temperature was obtained similarly to the condition 34 except that the power supply V was set as the power supply that applies the AC voltage having a frequency smaller than the reference resonance frequency by 30 kHz to the element L3. That is, in condition 46, the frequency smaller by 30 kHz than the predetermined resonance frequency for exciting the coil 53 was set as the frequency of the voltage applied to the element L3.

### (Condition 47)

In condition 47, the relationship between the electric signal responding to the magnitude of the voltage drop occurring in the element R4 and the temperature was obtained similarly to condition 46 except that the element L2 was set as an element having the first coupling constant.

### (Condition 48)

In condition 48, the relationship between the electric signal responding to the magnitude of the voltage drop occurring in the element R4 and the temperature was obtained similarly to condition 46 except that the element L2 was set as an element having the second coupling constant.

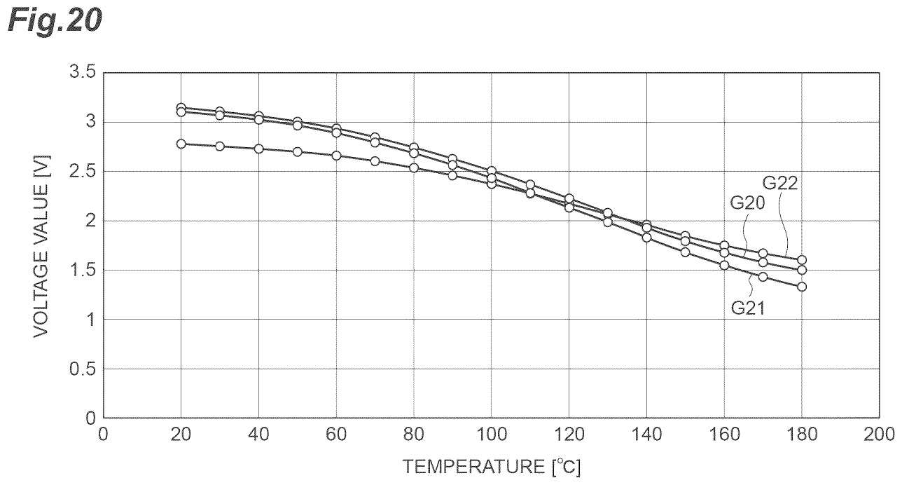

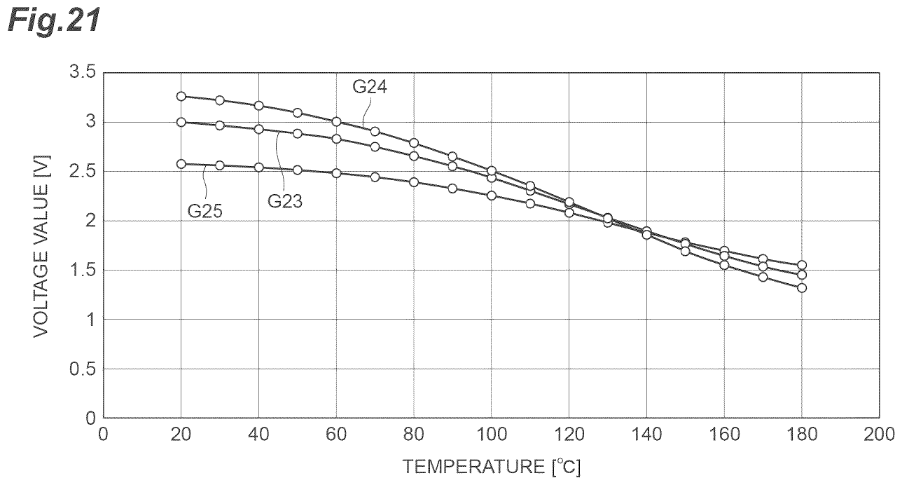

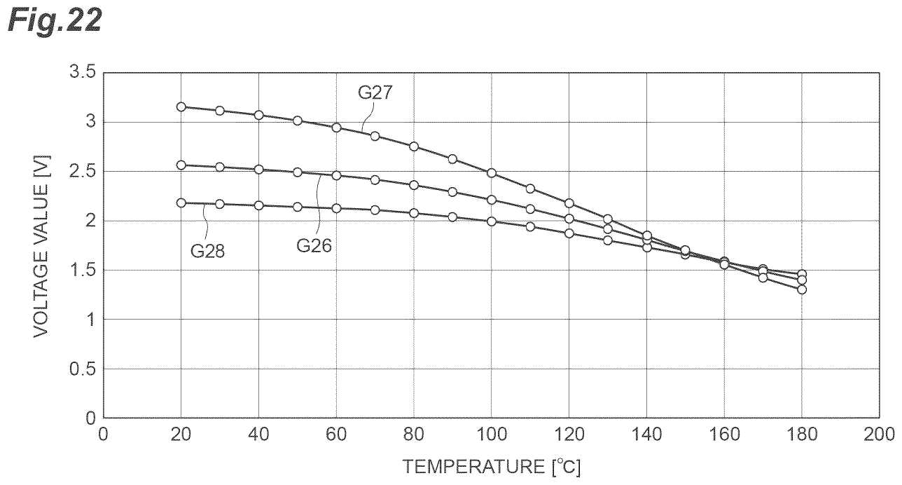

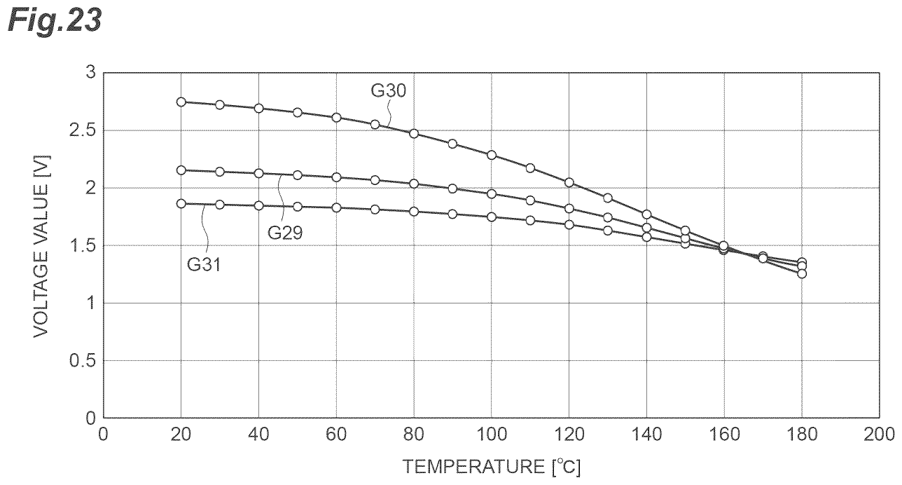

FIG. 19 illustrates results of conditions 34 to 36. FIG. 20 illustrates results of conditions 37 to 39. FIG. 21 illustrates results of conditions 40 to 42. FIG. 22 illustrates results of conditions 43 to 45. FIG. 23 illustrates results of conditions 46 to 48. In the graphs illustrated in FIGS. 19 to 23, the horizontal axis represents the temperature [° C.], and the vertical axis represents the voltage value [V] based on the electric signal responding to the magnitude of the voltage drop.

In FIG. 19, a relationship G17 indicates the relationship between the voltage drop and the temperature obtained under condition 34. A relationship G18 indicates the relationship between the voltage drop and the temperature obtained under condition 35. A relationship G19 indicates the relationship between the voltage drop and the temperature obtained under condition 36.

In FIG. 20, a relationship G20 indicates the relationship between the voltage drop and the temperature obtained under condition 37. A relationship G21 indicates the relationship between the voltage drop and the temperature obtained under condition 38. A relationship G22 indicates the relationship between the voltage drop and the temperature obtained under the condition 39.

In FIG. 21, a relationship G23 indicates the relationship between the voltage drop and the temperature obtained under condition 40. A relationship G24 indicates the relationship between the voltage drop and the temperature obtained under the condition 41. A relationship G25 indicates the relationship between the voltage drop and the temperature obtained under the condition 42.

In FIG. 22, a relationship G26 indicates the relationship between the voltage drop and the temperature obtained under condition 43. A relationship G27 indicates the relationship between the voltage drop and the temperature obtained under the condition 44. A relationship G28 indicates the relationship between the voltage drop and the temperature obtained under the condition 45.

In FIG. 23, a relationship G29 indicates the relationship between the voltage drop and the temperature obtained under condition 46. A relationship G30 indicates the relationship between the voltage drop and the temperature obtained under the condition 47. A relationship G31 indicates the relationship between the voltage drop and the temperature obtained under the condition 48.

As illustrated in FIGS. 19 and 20, it can be seen that the deviation of each of the relationships G21 and G22 with respect to the relationship G20 is smaller than the deviation of each of the relationships G18 and G19 with respect to the relationship G17 in a range of higher than or equal to 100° C. and lower than or equal to 180° C. In the relationships G20 to G22, particularly in a vicinity of 120° C., the deviation of each of the relationships G21 and G22 with respect to the relationship G20 is reduced.

From this, it can be seen that even if the coupling constants between the coil 53 and the coil 61 are deviated from the design values, when the frequency of the voltage applied to the coil 61 is smaller by 5 kHz than the predetermined resonance frequency for exciting the coil 53, the deviation in the output electric signal amplitude is reduced in the range of higher than or equal to 100° C. and lower than or equal to 180° C.

As illustrated in FIGS. 19 and 21, it can be seen that the deviation of each of the relationships G24 and G25 with respect to the relationship G23 is smaller than the deviation of each of the relationships G18 and G19 with respect to the relationship G17 in the range of higher than or equal to 100° C. and lower than or equal to 180° C. In particular, it can be seen that the deviation of each of the relationships G24 and G25 with respect to the relationship G23 is smaller than the deviation of each of the relationships G18 and G19 with respect to the relationship G17 in a range of higher than or equal to 120° C. and lower than or equal to 180° C. In the relationships G23 to G25, particularly in a vicinity of 130° C., the deviation of each of the relationships G24 and G25 with respect to the relationship G23 is reduced. From this, it can be seen that even if the coupling constants between the coil 53 and the coil 61 is deviated from the design values, when the frequency of the voltage applied to the coil 61 is smaller by 10 kHz than the predetermined resonance frequency for exciting the coil 53, the deviation in the output electric signal amplitude is reduced in the range of higher than or equal to 100° C. and lower than or equal to 180° C.

As illustrated in FIGS. 19 and 22, it can be seen that the deviation of each of the relationships G27 and G28 with respect to the relationship

G26 is smaller than the deviation of each of the relationships G18 and G19 with respect to the relationship G17 in the range of higher than or equal to 100° C. and lower than or equal to 180° C. In particular, it can be seen that the deviation of each of the relationships G27 and G28 with respect to the relationship G26 is smaller than the deviation of each of the relationships

G18 and G19 with respect to the relationship G17 in a range of higher than or equal to 130° C. and lower than or equal to 180° C. In the relationships G26 to G28, particularly in a vicinity of 150° C., the deviation of each of the relationships G27 and G28 with respect to the relationship G26 is reduced. From this, it can be seen that even if the coupling constants between the coil 53 and the coil 61 are deviated from the design values, when the frequency of the voltage applied to the coil 61 is smaller by 20 kHz than the predetermined resonance frequency for exciting the coil 53, the deviation in the output electric signal amplitude is reduced in the range of higher than or equal to 100° C. and lower than or equal to 180° C.

As illustrated in FIGS. 19 and 23, it can be seen that the deviation of each of the relationships G30 and G31 with respect to the relationship G29 is smaller than the deviation of each of the relationships G18 and G19 with respect to the relationship G17 in the range of higher than or equal to 100° C. and lower than or equal to 180° C. In particular, it can be seen that the deviation of each of the relationships G30 and G31 with respect to the relationship G29 is smaller than the deviation of each of the relationships G18 and G19 with respect to the relationship G17 in a range of higher than or equal to 140° C. and lower than or equal to 180° C. In the relationships G29 to G31, particularly in a vicinity of 170° C., the deviation of each of the relationships G30 and G31 with respect to the relationship G29 is reduced. From this, it can be seen that even if the coupling constants between the coil 53 and the coil 61 is deviated from the design values, when the frequency of the voltage applied to the coil 61 is smaller by 30 kHz than the predetermined resonance frequency for exciting the coil 53, the deviation in the output electric signal amplitude is reduced in the range of higher than or equal to 100° C. and lower than or equal to 180° C.

From this, it can be seen that even if the coupling constants between the coil 53 and the coil 61 are deviated from the design values, in the case where the frequency of the voltage applied to the coil 61 is smaller than the predetermined resonance frequency for exciting the coil 53 and the difference between the frequency and the predetermined resonance frequency is greater than or equal to 5 kHz and less than or equal to 30 kHz, the deviation in the output electric signal amplitude is reduced. Therefore, in the case where the frequency of the voltage applied to the coil 61 is smaller than the predetermined resonance frequency for exciting the coil 53 and the difference between the frequency and the predetermined resonance frequency is greater than or equal to 5 kHz and less than or equal to 30 kHz, the magnet temperature information output device 1 accurately outputs the temperature information regarding the temperature of the permanent magnet 25.

What is claimed is:

1. A magnet temperature information output device that is provided for a rotating electrical machine including a stator and a rotor in which a permanent magnet is disposed, and that is arranged to output temperature information regarding a temperature of the permanent magnet, the magnet temperature information output device comprising:
a first element provided on the rotor, the first element including a temperature sensitive element whose electric resistance changes in response to the temperature of the permanent magnet, and a first coil electrically connected to the temperature sensitive element;
a second element provided on the stator, the second element including a second coil arranged to be magnetically coupled to the first coil;
an electric resistance element electrically connected to the second element; and
an output section electrically connected to the second element and the electric resistance element; wherein
the output section is arranged to output an electric signal responding to a magnitude of a voltage drop occurring in the electric resistance element as the temperature information.

2. The magnet temperature information output device according to claim 1, wherein
the electric resistance element has an electric resistance of greater than or equal to Zₒ^{0.50}×Z₁₅₀^{0.28} and less than or equal to Zₒ^{0.50}×Z₁₅₀^{0.71},
Z₁₅₀ is a combined impedance of the first element and the second element in a state where the first coil and the second coil are magnetically coupled and a temperature of the temperature sensitive element is 150° C., and
Zₒ is a combined impedance of the first element and the second element in a state where the first coil and the second coil are magnetically coupled, without the temperature sensitive element included in the first element.

3. The magnet temperature information output device according to claim 1, wherein
the second element further includes a capacitor forming an LC resonance circuit with the second coil.

4. The magnet temperature information output device according to claim 1, wherein
the first element further includes a capacitor forming an LC resonance circuit with the first coil.

5. The magnet temperature information output device according to claim 1, wherein
the first element further includes a capacitor forming an LC resonance circuit with the first coil, and
the second element further includes a capacitor forming an LC resonance circuit with the second coil.

6. The magnet temperature information output device according to claim 5, wherein
the second coil is arranged to be applied with a voltage having a frequency smaller than a predetermined resonance frequency for exciting the first coil.

7. The magnet temperature information output device according to claim 6, wherein
a difference between the frequency and the predetermined resonance frequency is greater than or equal to 5 kHz and less than or equal to 30 KHz.

8. A rotating electrical machine comprising:
a stator;
a rotor in which a permanent magnet is disposed; and
a magnet temperature information output device that is arranged to output temperature information regarding a temperature of the permanent magnet, wherein
the magnet temperature information output device includes:
a first element provided on the rotor, the first element including a temperature sensitive element whose electric resistance changes in response to the temperature of the permanent magnet, and a first coil electrically connected to the temperature sensitive element;
a second element provided on the stator, the second element including a second coil arranged to be magnetically coupled to the first coil;
an electric resistance element electrically connected to the second element; and
an output section electrically connected to the second element and the electric resistance element, and
the output section is arranged to output an electric signal responding to a magnitude of a voltage drop occurring in the electric resistance element as the temperature information.

9. The rotating electrical machine according to claim 8, wherein
the electric resistance element has an electric resistance of greater than or equal to Zₒ^{0.50}×Z₁₅₀^{0.28} and less than or equal to Zₒ^{0.50}×Z₁₅₀^{0.71},
Z₁₅₀ is a combined impedance of the first element and the second element in a state where the first coil and the second coil are magnetically coupled and a temperature of the temperature sensitive element is 150° C., and
Zₒ is a combined impedance of the first element and the second element in a state where the first coil and the second coil are magnetically coupled, without the temperature sensitive element included in the first element.

10. The rotating electrical machine according to claim 8, wherein
the second element further includes a capacitor forming an LC resonance circuit with the second coil.

11. The rotating electrical machine according to claim 8, wherein
the first element further includes a capacitor forming an LC resonance circuit with the first coil.

12. The rotating electrical machine according to claim 8, wherein
the first element further includes a capacitor forming an LC resonance circuit with the first coil, and
the second element further includes a capacitor forming an LC resonance circuit with the second coil.

13. The rotating electrical machine according to claim 12, wherein
the second coil is arranged to be applied with a voltage having a frequency smaller than a predetermined resonance frequency for exciting the first coil.

14. The rotating electrical machine according to claim 13, wherein
a difference between the frequency and the predetermined resonance frequency is greater than or equal to 5 kHz and less than or equal to 30 KHz.

15. The rotating electrical machine according to claim 8, wherein
the first coil and the second coil are disposed to oppose each other in a rotation axis direction of the rotor in a state where the rotor is at a predetermined rotation angle position.

16. The rotating electrical machine according to claim 8, wherein
the rotor includes a rotor core,
the entire permanent magnet and at least a part of the first coil are positioned in the rotor core,
the permanent magnet includes a pair of surfaces perpendicular to a rotation axis direction of the rotor, and
the temperature sensitive element is disposed to be in contact with a surface of the pair of surfaces that is closer to the second coil in a state where the rotor is at a predetermined rotational angle position.

17. The rotating electrical machine according to claim 16, wherein
the rotor core includes a pair of end surfaces perpendicular to the rotation axis direction, and
an end surface of the pair of end surfaces closer to the second coil is on the same plane as an end of the first coil in the rotation axis direction.

18. The rotating electrical machine according to claim 16, wherein
the rotor core includes a plurality of steel sheets stacked in the rotation axis direction and a plate,
the plurality of steel sheets have magnetism,
the plate has electric conductivity, and is disposed on a steel sheet disposed on an outermost side in the rotation axis direction of the rotor and closer to the second coil among the plurality of steel sheets, and
the first coil is embedded in the plate.

19. A magnet temperature acquisition device comprising:
a magnet temperature information output device that is provided for a rotating electrical machine including a stator, and a rotor in which a permanent magnet is disposed, and that is arranged to output temperature information regarding a temperature of the permanent magnet, wherein
the magnet temperature information output device includes:
a first element provided on the rotor, the first element including a temperature sensitive element whose electric resistance changes in response to the temperature of the permanent magnet, and a first coil electrically connected to the temperature sensitive element;
a second element provided on the stator, the second element including a second coil arranged to be magnetically coupled to the first coil;
an electric resistance element electrically connected to the second element; and
an output section electrically connected to the second element and the electric resistance element,
the output section is arranged to output an electric signal responding to a magnitude of a voltage drop occurring in the electric resistance element as the temperature information, and
the magnet temperature acquisition device is arranged to acquire the electric signal output from the magnet temperature information output device and is arranged to obtain the temperature of the permanent magnet based on the acquired electric signal.

20. A temperature information output device that is provided for a rotating electrical machine including a stator and a rotor in which a permanent magnet is disposed, and that is arranged to output temperature information regarding a temperature of a portion in the rotor, the temperature information output device comprising:
a first element provided on the rotor, the first element including a temperature sensitive element whose electric resistance changes in response to the temperature of the portion, and a first coil electrically connected to the temperature sensitive element;
a second element provided on the stator, the second element including a second coil arranged to be magnetically coupled to the first coil;
an electric resistance element electrically connected to the second element; and
an output section electrically connected to the second element and the electric resistance element; wherein
the output section is arranged to output an electric signal responding to a magnitude of a voltage drop occurring in the electric resistance element as the temperature information.
